(19) United States
(12) Patent Application Publication
(10) Pub. No.: US 2017/0190819 A1
(43) Pub. Date: Jul. 6, 2017

(54) POLYMERIZABLE COMPOSITION AND FILM USING THE SAME

(71) Applicant: DIC Corporation, Tokyo (JP)

(72) Inventors: Kouichi Endo, Kita-adachi-gun (JP); Yasuhiro Kuwana, Kita-adachi-gun (JP); Hidetoshi Nakata, Kita-adachi-gun (JP); Mika Yamamoto, Kita-adachi-gun (JP); Kazuaki Hatsusaka, Kita-adachi-gun (JP); Isa Nishiyama, Kita-adachi-gun (JP)

(73) Assignee: DIC Corporation, Tokyo (JP)

(21) Appl. No.: 15/312,884

(22) PCT Filed: Jun. 16, 2015
(86) PCT No.: PCT/JP2015/067273

§ 371 Date: Nov. 21, 2016

(30) Foreign Application Priority Data
Jun. 23, 2014 (JP) 2014-128155
Nov. 20, 2014 (JP) 2014-235544

(51) Int. Cl. C08F 220/68; C09D 133/14; G02B 1/08; C09K 19/38; G02B 5/30; C08F 222/20; C09D 135/02

(52) U.S. Cl. CPC C08F 220/68; C08F 222/20; C09D 133/14; C09D 135/02; C09K 19/3814; G02B 5/3016; G02B 1/08; C08F 2800/20

(57) ABSTRACT

It is an object of the present invention to provide a polymerizable liquid crystal composition that has an excellent storage stability and that enables a film formed by application of the composition to a base material and the subsequent exposure to heat or active energy rays to have a good adhesion to the base material. It is another object of the present invention to provide an optically anisotropic body that is produced using such a polymerizable composition and that has a good orientation. In particular, the present invention provides a polymerizable liquid crystal composition containing a polymerizable adhesion enhancer and a polymerizable liquid crystal compound. In addition, the present invention also provides an optically anisotropic body containing such a polymerizable liquid crystal composition.

### TECHNICAL FIELD

The present invention relates to a polymerizable liquid crystal composition that is useful as a component of an optically anisotropic body used for optical compensation in, for instance, liquid crystal devices, displays, optical components, colorants, security marking, laser-emitting members, or liquid crystal displays. The present invention also relates to an optically anisotropic body, retardation film, patterned retardation film, brightness-enhancing film, view angle compensation film, and antireflection film produced using such a composition.

### BACKGROUND ART

Polymerizable liquid crystal compositions serve as useful components of optically anisotropic bodies, and optically anisotropic bodies are applied to, for example, polarizing films and retardation films in a variety of liquid crystal displays. Polarizing films and retardation films are produced by applying a polymerizable liquid crystal composition onto a substrate; drying the solvent; aligning the molecules of the polymerizable liquid crystal composition with, for instance, an alignment film; and curing the polymerizable liquid crystal composition in this state through application of heat or irradiation with active energy rays. It is known that using a polymerizable cholesteric liquid crystal composition in which a chiral compound has been added to a polymerizable liquid crystal composition enables production of a circular polarization splitter, and application thereof to a brightness-enhancing film has been studied.

Such polymerizable liquid crystal compositions are generally applied onto glass substrates, plastic substrates, or alignment films optionally formed on these substrates in their usage and therefore need to be adhesive to base materials such as substrates and alignment films. A coating film, however, formed through polymerization of polymerizable compounds used in the polymerizable compositions are unsatisfactory in terms of the adhesion to base materials.

A technique for addressing such a problem has been reported, in which the hydrolysate of an alkoxysilane compound is applied onto a base material for surface treatment thereof. This surface treatment technique enables formation of a coating layer having a good adhesion to a base material; however, the formation of the coating layer needs additional steps. In addition, the molecular alignment of liquid crystal is uneven, and thus such a technique is insufficient in view of orientation (Patent Literature 1).

A technique for enhancing adhesion to a base material without a surface treatment has been reported; for example, an organic silicon compound having a primary amino group is added to a polymerizable liquid crystal composition (Patent Literature 2), or a compound that has a molecular structure including a carbon-carbon unsaturated bond and an isocyanate group as an active-hydrogen-reactive group is added to a polymerizable liquid crystal composition (Patent Literature 3). In each of these techniques, however, the added compound causes a decrease in the storage stability of the polymerizable liquid crystal composition.

### CITATION LIST

### Patent Literature

PTL 1: Japanese Unexamined Patent Application Publication No. 2005-258046

PTL 2: Japanese Unexamined Patent Application Publication No. 2006-126757

PTL 3: Japanese Unexamined Patent Application Publication No. 2013-147607

### SUMMARY OF INVENTION

### Technical Problem

It is an object of the present invention to provide a polymerizable liquid crystal composition that has an excellent storage stability and that enables a film formed by application of the composition to a base material and the subsequent exposure to heat or active energy rays to have a good adhesion to the base material. It is another object of the present invention to provide an optically anisotropic body that is produced using such a polymerizable composition and that has a good orientation.

### Solution to Problem

In order to achieve the above-mentioned objects, a polymerizable liquid crystal composition has been intensively studied, thereby accomplishing the present invention.

In particular, the present invention provides a polymerizable liquid crystal composition containing a polymerizable adhesion enhancer and a polymerizable liquid crystal compound. The present invention also provides an optically anisotropic body produced using such a polymerizable liquid crystal composition.

### Advantageous Effects of Invention

Use of the polymerizable liquid crystal composition of the present invention enables production of an optically anisotropic body having an excellent adhesion to a base material; hence, the polymerizable liquid crystal composition is usefully applied to optical materials used in, for example, a retardation films.

### Description of Embodiments

The best mode of the polymerizable liquid crystal composition of the present invention will now be described. The term “liquid crystal” of the polymerizable liquid crystal composition herein refers to that a polymerizable liquid crystal composition applied to a substrate and then subjected to removal of an organic solvent has liquid crystal properties. The term “liquid crystal” of a polymerizable liquid crystal compound herein refers to that a single polymerizable liquid crystal compound to be used has liquid crystal properties or that a mixture of polymerizable liquid crystal compounds to be used have liquid crystal properties. The polymerizable liquid crystal composition can be polymerized into a polymer (film) by either or both of irradiation with light, such as ultraviolet rays, and application of heat.

(Polymerizable Adhesion Enhancer)

The polymerizable liquid crystal composition of the present invention contains a polymerizable adhesion enhancer. The term “polymerizable adhesion enhancer” refers to a compound that is added to the polymerizable liquid crystal composition and that can well enhance the adhesion thereof to a base material such as a substrate or an alignment film that is optionally used. A specific example of the polymerizable adhesion enhancer is a compound (I) having at least one polymerizable functional group and a cyclic compound group with one to four rings.

The polymerizable functional group is preferably a group selected from polymerizable functional groups represented by Formulae (P-1) to (P-20).

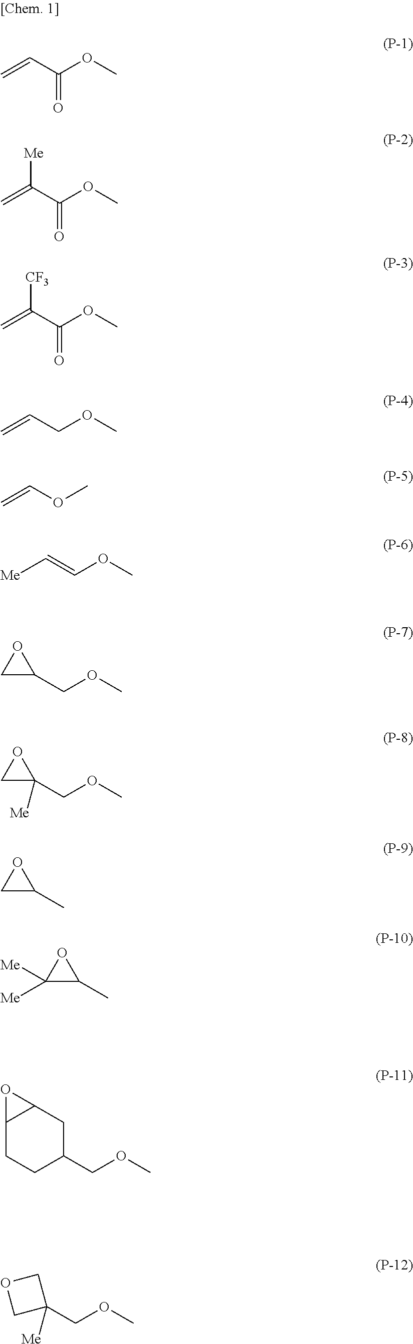

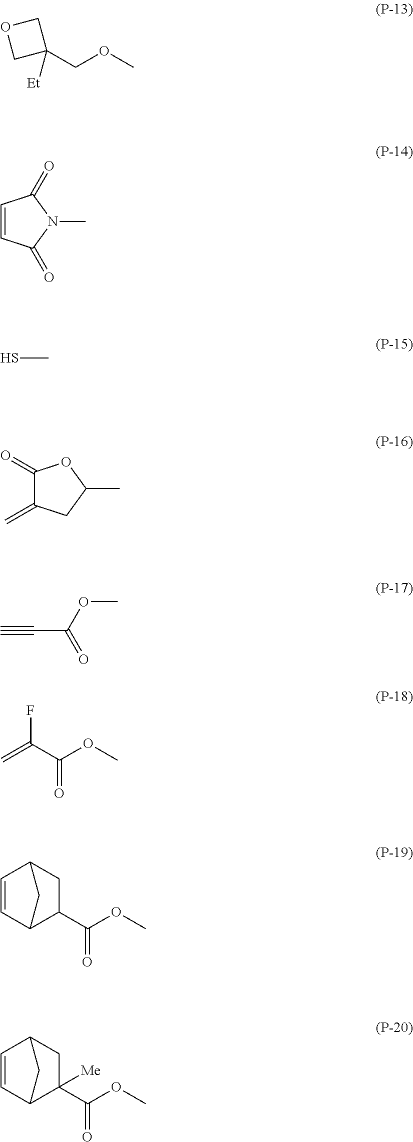

Such polymerizable functional groups are subjected to polymerization through radical polymerization, radical addition polymerization, cationic polymerization, or anionic polymerization. In particular, in the case where the polymerization involves exposure to ultraviolet, the groups represented by Formulae (P-1), (P-2), (P-3), (P-4), (P-5), (P-7), (P-11), (P-13), (P-15), and (P-18) are preferred; the groups represented by Formulae (P-1), (P-2), (P-3), (P-7), (P-11), and (P-13) are more preferred; the groups represented by Formulae (P-1), (P-2), and (P-3) are further preferred; and the groups represented by Formulae (P-1) and (P-2) are especially preferred. The number of the polymerizable functional groups in the compound (I) is preferably one, two, or three; in view of storage stability, it is more preferably one or two; and especially preferably one.

The cyclic compound group having 1 to 4 rings is preferably a monocyclic compound group having 3 to 9 carbon atoms and a monocyclic structure; a condensed ring compound group having 6 to 20 carbon atoms and 2 to 4 rings, in which 2 to 4 monocyclic compounds share 1 side with each other per unit; or a bridged compound group having 6 to 30 carbon atoms and 2 to 4 ring structures, which is a compound having a structure in which the two ends of the linear part of a substituent are bonded to a single monocyclic group but excludes the above-mentioned condensed ring compound having a structure in which 1 side is shared. In these cyclic compounds, the hydrogen atoms of an alkylene group may be substituted with one or more alkyl groups each having 1 to 5 carbon atoms; the cyclic compound is more preferably a monocyclic compound group having 3 to 5 carbon atoms, a condensed cyclic compound group having 6 to 10 carbon atoms and 2 to 4 rings, or a bridged compound group having 6 to 12 carbon atoms and 2 to 4 rings.

In particular, the cyclic compound group having 1 to 4 rings is further preferably a group selected from groups represented by General Formulae (I-1-1) to (I-1-11).

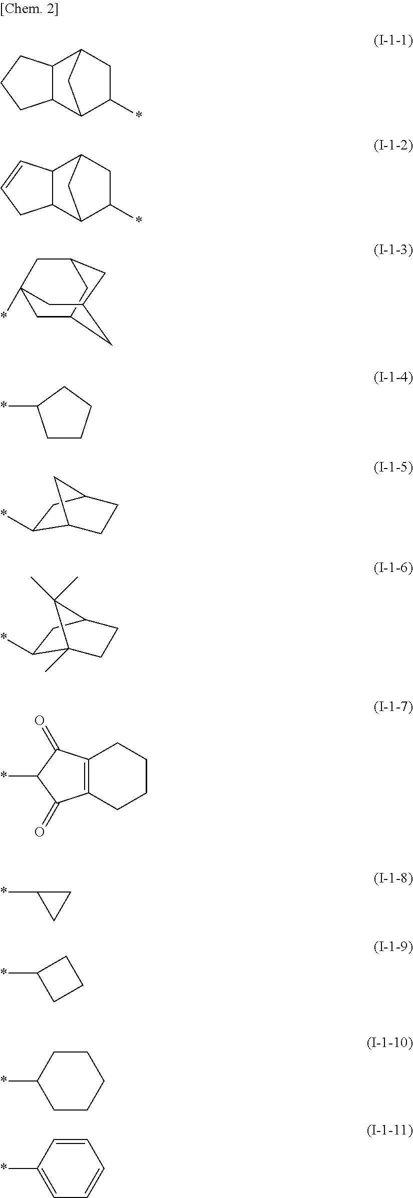

(in each of the formulae, the symbol * represents linkage; in General Formulae (I-1-1) to (I-1-11), one or more methylene groups are each independently optionally substituted with an oxygen atom, a nitrogen atom, a sulfur atom, or —CO— such that oxygen atoms are not directly bonded to each other; it is preferred that bond of oxygen atoms be particularly avoided because bond of hetero atoms, which are not a carbon atom and a hydrogen atom, is unstable; in the case where the linking group directly bonded to the cyclic compound group is an oxygen atom, the methylene group of the cyclic compound directly linked to this oxygen atom is not substituted with an oxygen atom)

Specific examples of the compound (I) include compounds represented by General Formula (I-1).

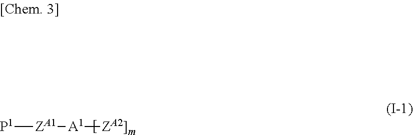

(in the formula, P¹ represents a polymerizable functional group; Z^{A1} represents a single bond or an alkylene group having 1 to 40 carbon atoms; the alkylene group may be linear or branched; in the alkylene group, one CH₂ group or two or more CH₂ groups not adjoining each other are each independently optionally substituted with —O—, —CO—, —COO—, —OCO—, —OCOO—, —CH═CH—, or —C≡C— such that oxygen atoms are not directly bonded to each other;

A¹ represents a cyclic compound group having 1 to 4 rings;
Z^{A2} represents a hydroxyl group, a carboxy group, or an alkyl group having 1 to 16 carbon atoms; the alkyl group may be linear or branched; in the alkyl group, one CH₂ group or two or more CH₂ groups not adjoining each other are each independently optionally substituted with —O—, —CO—, —COO—, or —OCO— such that oxygen atoms are not directly bonded to each other;
m represents 0, 1, 2, or 3; and in the case where m represents 2 or 3, the multiple Z^{A2}'s may be the same as or different from each other)

In particular, P¹ is preferably represented by Formula (P-1) or (P-2);

Z^{A1} preferably represents a single bond or an alkylene group having 1 to 30 carbon atoms, and more preferably a single bond or an alkylene group having 1 to 20 carbon atoms. In the alkylene group, one CH₂ group or two or more CH₂ groups not adjoining each other are each independently optionally substituted with —O—, —CO—, —COO—, or —OCO— such that oxygen atoms are not directly bonded to each other; and such a CH₂ group is preferably unsubstituted or substituted with —O—, —COO—, or —OCO—.
Z^{A2} preferably represents a hydroxyl group, a carboxyl group, or a linear or branched alkyl group having 1 to 8 carbon atoms; and more preferably a hydroxyl group, a carboxyl group, or a linear alkyl group having 1 to 4 carbon atoms.
m is preferably 0, 1, or 2; in the case where Z^{A2} is a hydroxyl group or a carboxyl group, m is preferably 1; and in the case where Z^{A2} is an alkyl group, m is preferably 1 or 2.
A¹ preferably represents a group selected from the groups represented by General Formulae (I-1-1) to (I-1-11), more preferably a group selected from the groups represented by General Formulae (I-1-1) to (I-1-10), and further preferably a group selected from the groups represented by General Formulae (I-1-1) to (I-1-8). In the case where any of the groups represented by General Formulae (I-1-4) and (I-1-8) to (I-1-10), which are monocyclic compound groups each having one ring, is selected, one or more methylene groups in the ring are preferably each independently substituted with an oxygen atom, a nitrogen atom, a sulfur atom, or —CO— such that oxygen atoms are not directly bonded to each other, and one or two methylene groups in the ring are especially preferably each independently substituted with an oxygen atom such that oxygen atoms are not directly bonded to each other.
In particular, -A¹-(Z^{A2})m in General Formula (I-1) preferably represents a group selected from groups represented by General Formulae (I-2-1) to (I-2-22).

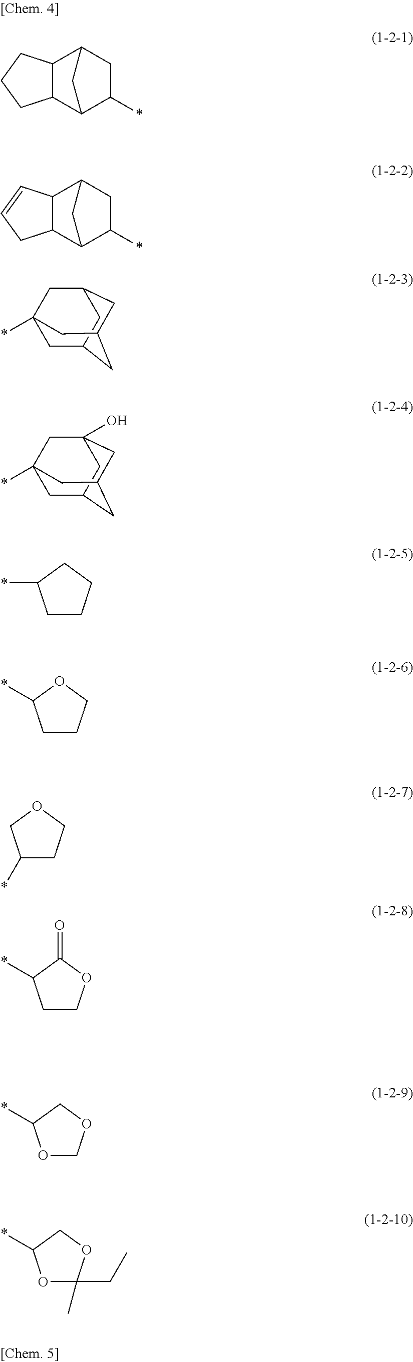

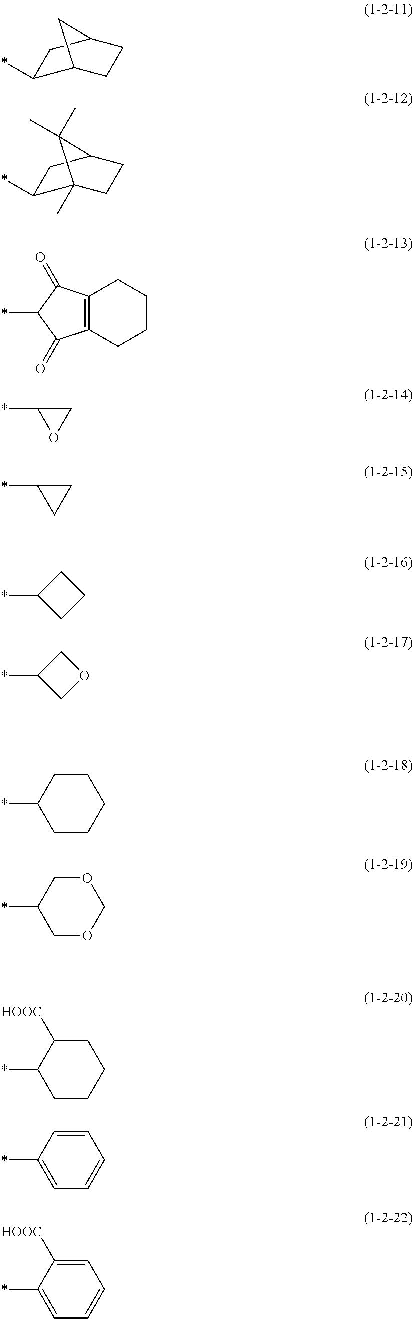

In each of the formulae, the symbol * represents the linkage to Z¹. Among the groups represented by General Formulae (I-2-1) to (I-2-22), a group selected from the groups represented by General Formulae (I-2-1) to (I-2-20) is preferred, and a group selected from the groups represented by General Formulae (I-2-1) to (I-2-14) is more preferred.

More specific examples of the compound (I) include compounds represented by General Formulae (I-3-1) to (I-3-17).

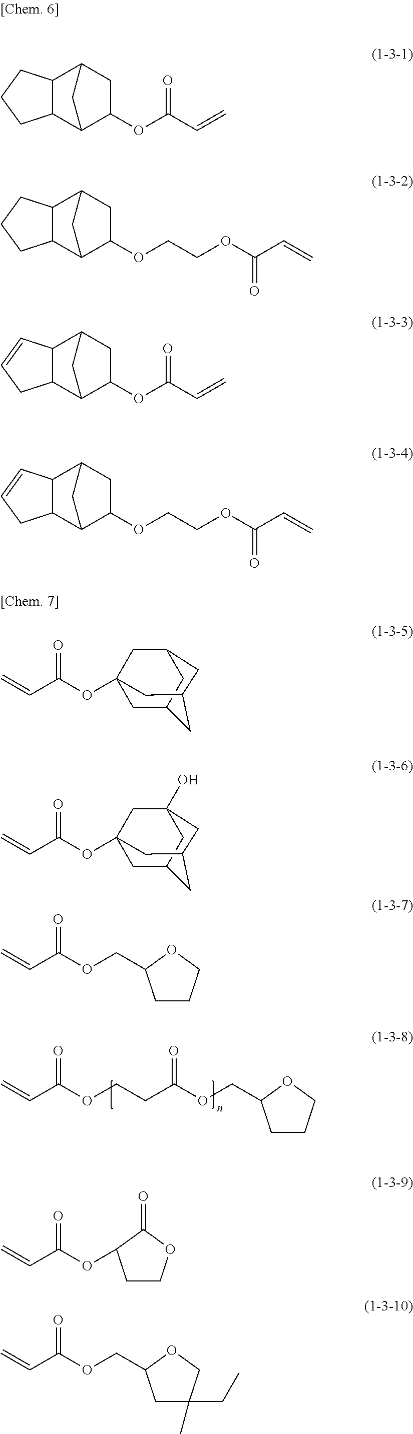

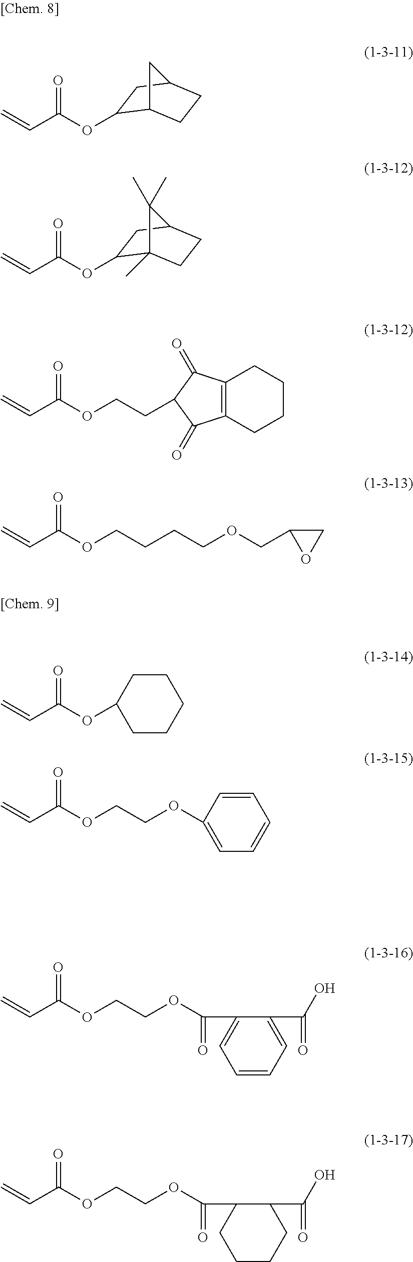

n represents an integer from 0 to 6.

Among the compounds represented by Formulae (I-3-1) to (I-3-17), the compounds represented by Formulae (I-3-1) to (I-3-14) are preferred, and the compounds represented by Formulae (I-3-1) to (I-3-13) are more preferred.

These polymerizable adhesion enhancers can be used alone or in combination.

The amount of the polymerizable adhesion enhancer is preferably in the range of 1 to 15 parts by mass, more preferably 1 to 12 parts by mass, further preferably 1 to 10 parts by mass, and especially preferably 2 to 8 parts by mass relative to 100 parts by mass of the total of a polymerizable liquid crystal compound, polymerizable chiral compound, and polymerizable discotic compound contained in the polymerizable liquid crystal composition. The amount of the polymerizable adhesion enhancer contained in the polymerizable liquid crystal composition is adjusted to be within a specific range, so that a solution thereof has an excellent storage stability and that the polymerizable liquid crystal composition can be formed into an optically anisotropic body having an excellent orientation.

### (Polymerizable Liquid Crystal Compound)

Any polymerizable liquid crystal compound can be used in the present invention provided that the compound has at least one polymerizable functional group and liquid crystal properties when it is used alone or in combination with another compound. Known polymerizable liquid crystal compounds can be used.

Examples of the polymerizable liquid crystal compounds include rod-like polymerizable liquid crystal compounds each having a polymerizable functional group, such as a vinyl group, an acryl group, or a (meth)acryl group, and a rigid part called mesogen in which multiple structures such as a 1,4-phenylene group and a 1,4-cyclohexylene group are boded to each other, which are disclosed in Handbook of Liquid Crystals (D. Demus, J. W. Goodby, G. W. Gray, H. W. Spiess, V. Vill, Eds.; Wiley-VCH: 1998); Ekisho no Kagaku. Kikan kagaku sosetsu No. 22. (The Chemical Society of Japan: 1994); and Japanese Unexamined Patent Application Publication Nos. 7-294735, 8-3111, 8-29618, 11-80090, 11-116538, and 11-148079, and rod-like polymerizable liquid crystal compounds each having a maleimide group, which are disclosed in Japanese Unexamined Patent Application Publication Nos. 2004-2373 and 2004-99446. In particular, the rod-like liquid crystal compound having a polymerizable group can be easily produced so as to have a liquid crystal temperature within a range including a low temperature close to room temperature, and such a rod-like liquid crystal compound is therefore preferred.

Specifically, the polymerizable liquid crystal compound is preferably any of compounds represented by General Formula (II).

[Chem. 10]

P²—(S¹—X¹)_{q1}-MG-R² (II)

In the formula, P² represents a polymerizable functional group; S¹ represents an alkylene group having 1 to 18 carbon atoms (in the alkylene group, a hydrogen atom is optionally substituted with at least one halogen atom, CN group, or alkyl group having 1 to 8 carbon atoms and a polymerizable functional group; and one CH₂ group or two or more CH₂ groups not adjoining each other are each independently optionally substituted with —O—, —COO—, —OCO—, or —OCO—O—); X¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond (where P²—S¹ and S¹—X¹ exclude —O—O—, —O—NH—, —S—S—, and —O—S—); q1 represents 0 or 1; MG represents a mesogenic group; R² represents a hydrogen atom, a halogen atom, a cyano group, or a linear or branched alkyl group having 1 to 12 carbon atoms; the alkyl group may be linear or branched; in the alkyl group, one —CH₂— or two or more —CH₂—'s not adjoining each other are each independently optionally substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—; R² alternatively represents a group represented by General Formula (II-a)

[Chem. 11]

—(X²—S²)_{q2}—P³ (II-a)

(in the formula, P³ represents a polymerizable functional group; S² has the same definition as S¹; X² has the same definition as X¹ (where P³—S and S²—X² exclude —O—O—, —O—NH—, —S—S—, and —O—S—); and q² represents 0 or 1); and the mesogenic group MG is represented by General Formula (II-b)

[Chem. 12]

—(B1-Z1)ᵣ₁-B2-Z2-B3 (II-b)

(in the formula, B1, B2, and B3 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, and may have, as a substituent, at least one selected from F, Cl, CF₃, OCF₃, a CN group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, an alkenoyloxy group having 2 to 8 carbon atoms, and/or a substituent represented by General Formula (II-c)

[Chem. 13]

—(X³)^{q4}—(S³)_{q3}—P⁴ (II-c)

(in the formula, P⁴ represents a reactive functional group;

S³ has the same definition as S¹; X³ represents —O—, —COO—, —OCO—, —OCH₂—, —CH₂O—, —CH₂CH₂OCO—, —COOCH₂CH₂—, —OCOCH₂CH₂—, or a single bond; q³ represents 0 or 1; q⁴ represents 0 or 1 (where P⁴—S³ and S³—X³ exclude —O—O—, —O—NH—, —S—S—, and —O—S—)); Z1 and Z2 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, an alkyl group having 2 to 10 carbon atoms and optionally a halogen atom, or a single bond; r1 represents 0, 1, 2, or 3; and in the case where B1 and Z1 are multiple, the corresponding ones of them may be the same as or different from each other).

P², P³, and P⁴ each independently represent a substituent selected from polymerizable groups represented by Formulae (P-2-1) to (P-2-20).

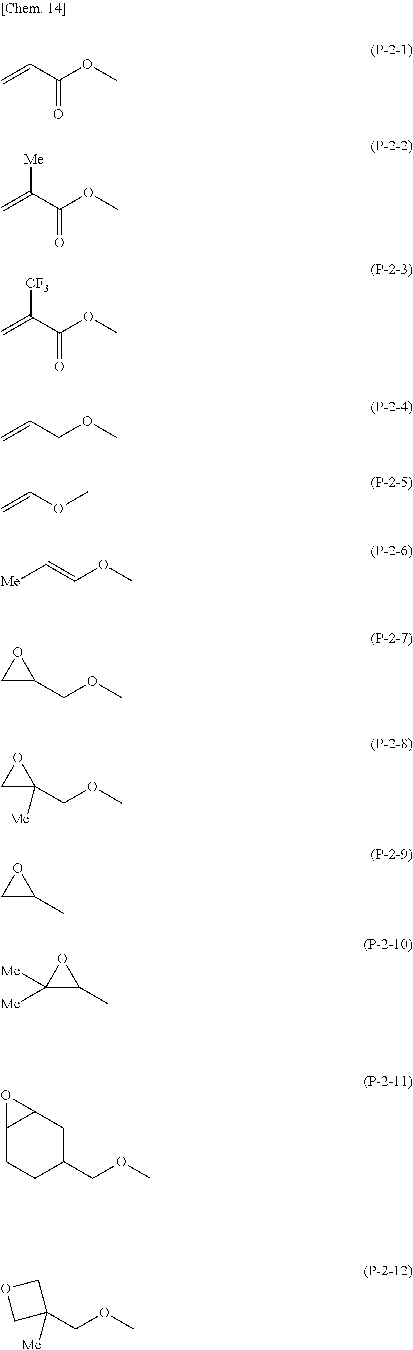

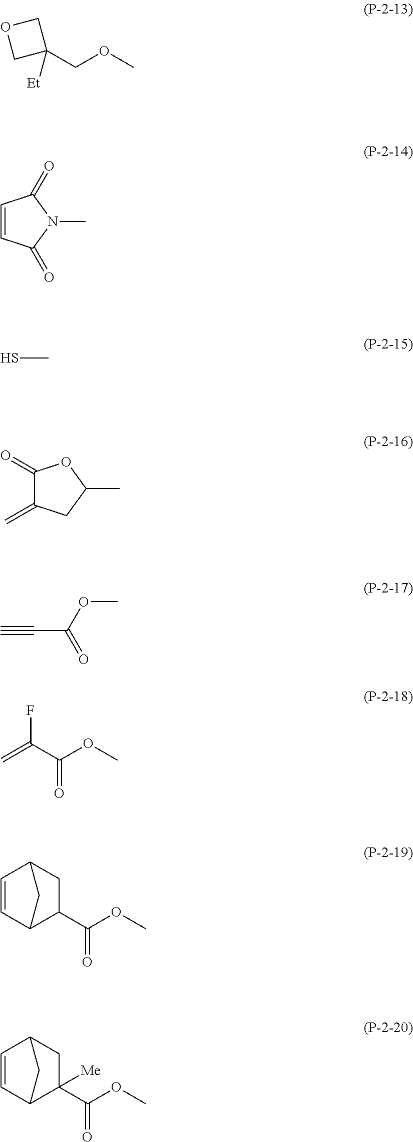

Among such polymerizable functional groups, the functional groups represented by Formulae (P-2-1), (P-2-2), (P-2-7), (P-2-12), and (P-2-13) are preferred in terms of an enhancement in polymerizability; and the functional groups represented by Formulae (P-2-1) and (P-2-2) are more preferred.

### (Monofunctional Polymerizable Liquid Crystal Compound)

Among compounds represented by General Formula (II), a preferred monofunctional polymerizable liquid crystal compound having one polymerizable functional group per molecule is any of compounds represented by General Formula (II-2-1).

[Chem. 15]

P²—(S¹—X¹)_{q1}-MG-R²¹ (II-2-1)

In the formula, P², S¹, X¹, q1, and MG have the same definitions as those in General Formula (II); R²¹ represents a linear or branched alkyl group having 1 to 12 carbon atoms or a linear or branched alkenyl group having 1 to 12 carbon atoms, in which a hydrogen atom, a halogen atom, a cyano group, one —CH₂—, or two or more —CH₂—'s not adjoining each other are each independently optionally substituted with —O—, —S—, —CO—, —COO—, —OCO—, —CO—S—, —S—CO—, —O—CO—O—, —CO—NH—, —NH—CO—, —NH—, —N(CH₃)—, —CH═CH—COO—, —CH═CH—OCO—, —COO—CH═CH—, —OCO—CH═CH—, —CH═CH—, —CF═CF—, or —C≡C—; in each of the alkyl group and alkenyl group, at least one hydrogen atom is optionally substituted with a halogen atom or a cyano group; and in the case where multiple hydrogen atoms are subjected to the substitution, they may be substituted with the same substituent or different substituents.

Examples of the compound represented by General Formula (II-2-1) include, but are not limited to, compounds represented by General Formulae (II-2-1-1) to (II-2-1-4).

[Chem. 16]

P²—(S¹—X¹)_{q1}—B2-Z2-B3-R²¹ (II-2-1-1)

P²—(S¹—X¹)_{q1}—B11-Z11-B2-Z2-B3-R²¹ (II-2-1-2)

P²—(S¹—X¹)^{q1}—B11-Z11-B12-Z12-B2-Z2-B3-R²¹ (II-2-1-3)

P²—(S¹—X¹)_{q1}—B11-Z11-B12-Z12-B13-Z13-B2-Z2-B3-R²¹ (II-2-1-4)

In the formulae, P², S¹, X¹, and q1 have the same definitions as those in General Formula (II);

B11, B12, B13, B2, and B3 have the same definitions as B1 to B3 in General Formula (II-b); B11, B12, B13, B2, and B3 may be the same as or different from each other;
Z11, Z12, Z13, and Z2 have the same definitions as Z1 to Z3 in General Formula (II-b); Z11, Z12, Z13, and Z2 may be the same as or different from each other;
R²¹ represents a linear or branched alkyl group having 1 to 12 carbon atoms or a linear or branched alkenyl group having 1 to 12 carbon atoms, in which a hydrogen atom, a halogen atom, a cyano group, one —CH₂—, or two or more —CH₂—'s not adjoining each other are each independently optionally substituted with —O—, —S—, —CO—, —COO—, —OCO—, —CO—S—, —S—CO—, —O—CO—O—, —CO—NH—, —NH—CO—, —NH—, —N(CH₃)—, —CH═CH—COO—, —CH═CH—OCO—, —COO—CH═CH—, —OCO—CH═CH—, —CH═CH—, —CF═CF—, or —C≡C—; in each of the alkyl group and alkenyl group, at least one hydrogen atom is optionally substituted with a halogen atom or a cyano group; and in the case where multiple hydrogen atoms are subjected to the substitution, they may be substituted with the same substituent or different substituents.

Examples of the compounds represented by General Formulae (II-2-1-1) to (II-2-1-4) include, but are not limited to, compounds represented by Formulae (II-2-1-1-1) to (II-2-1-1-26).

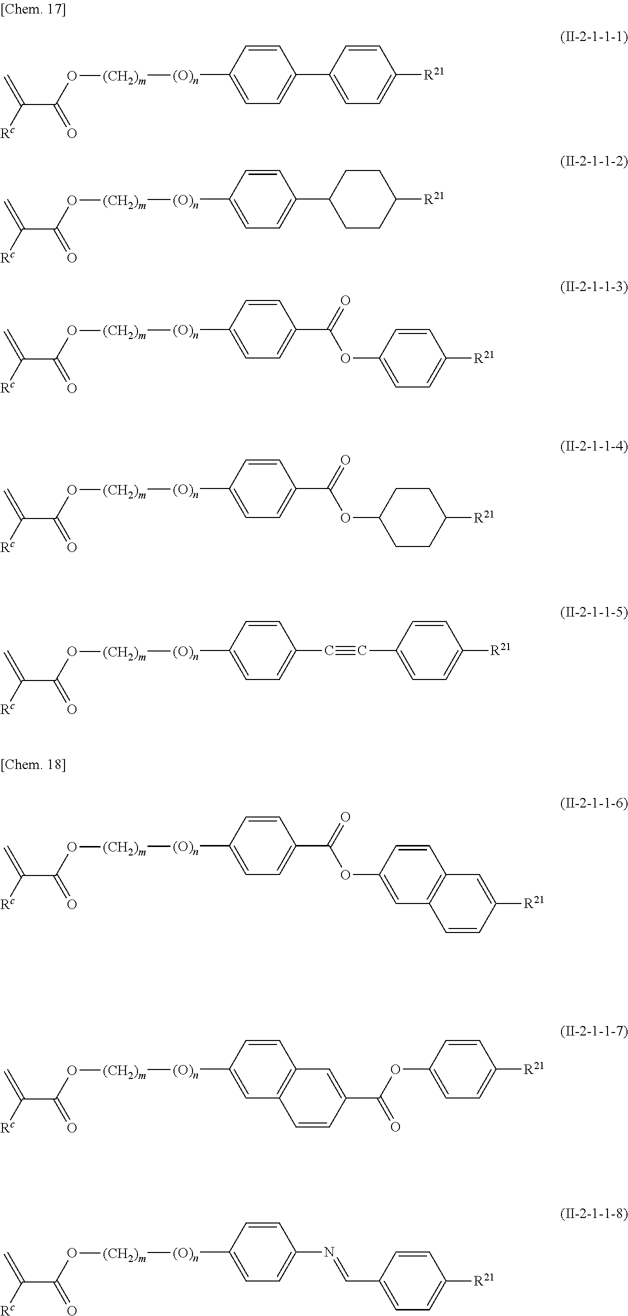

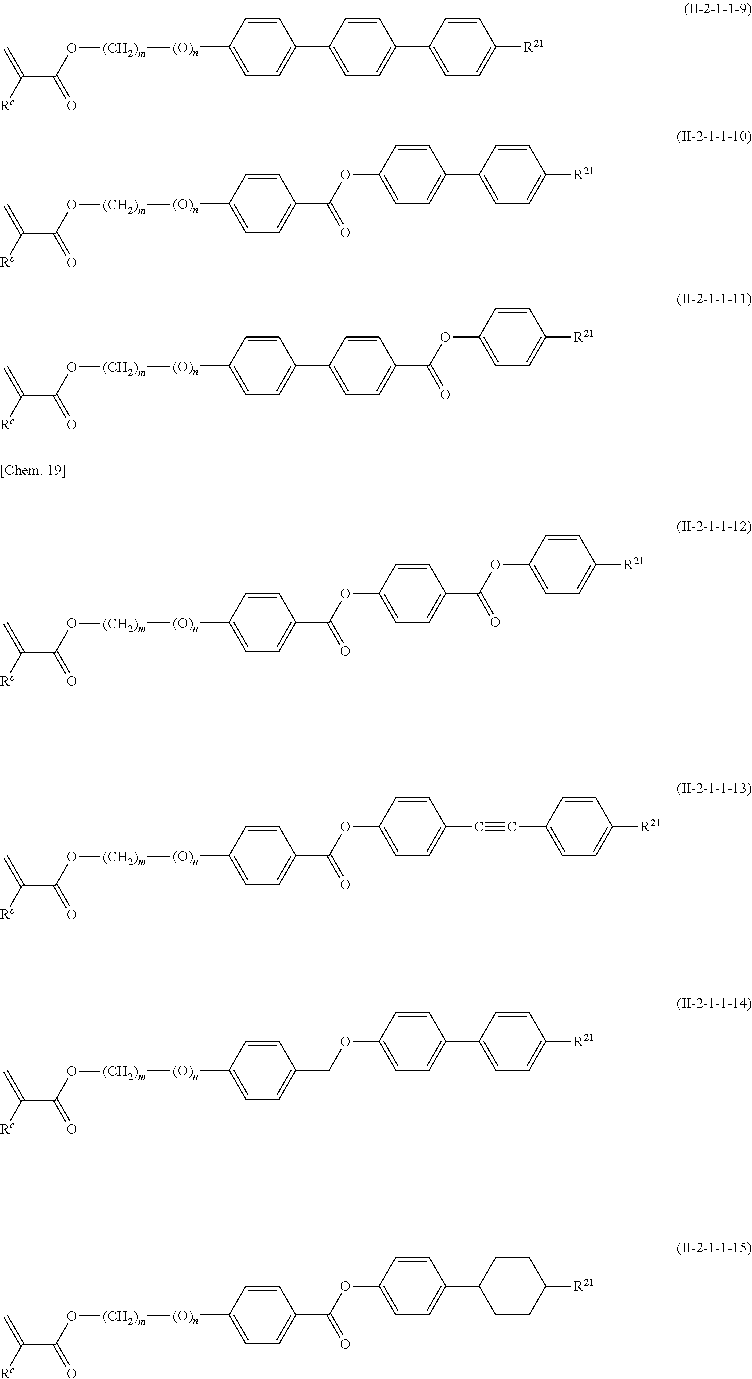

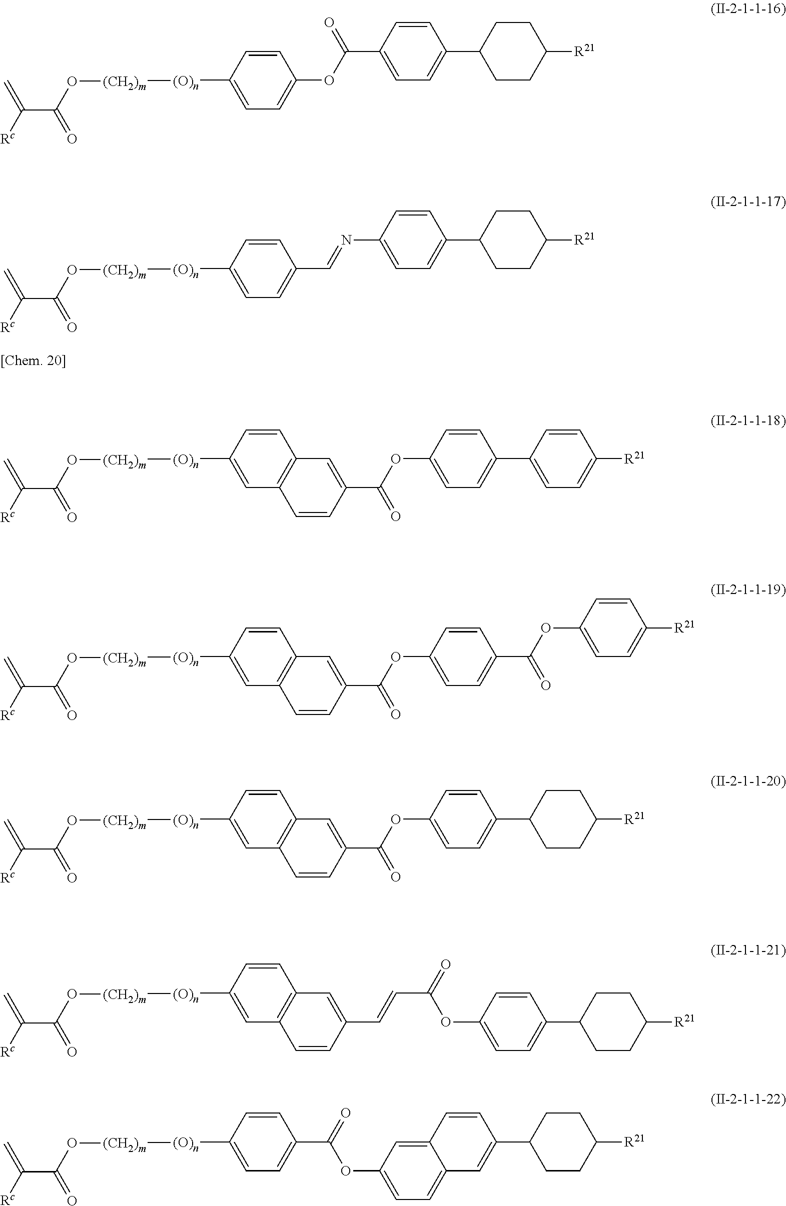

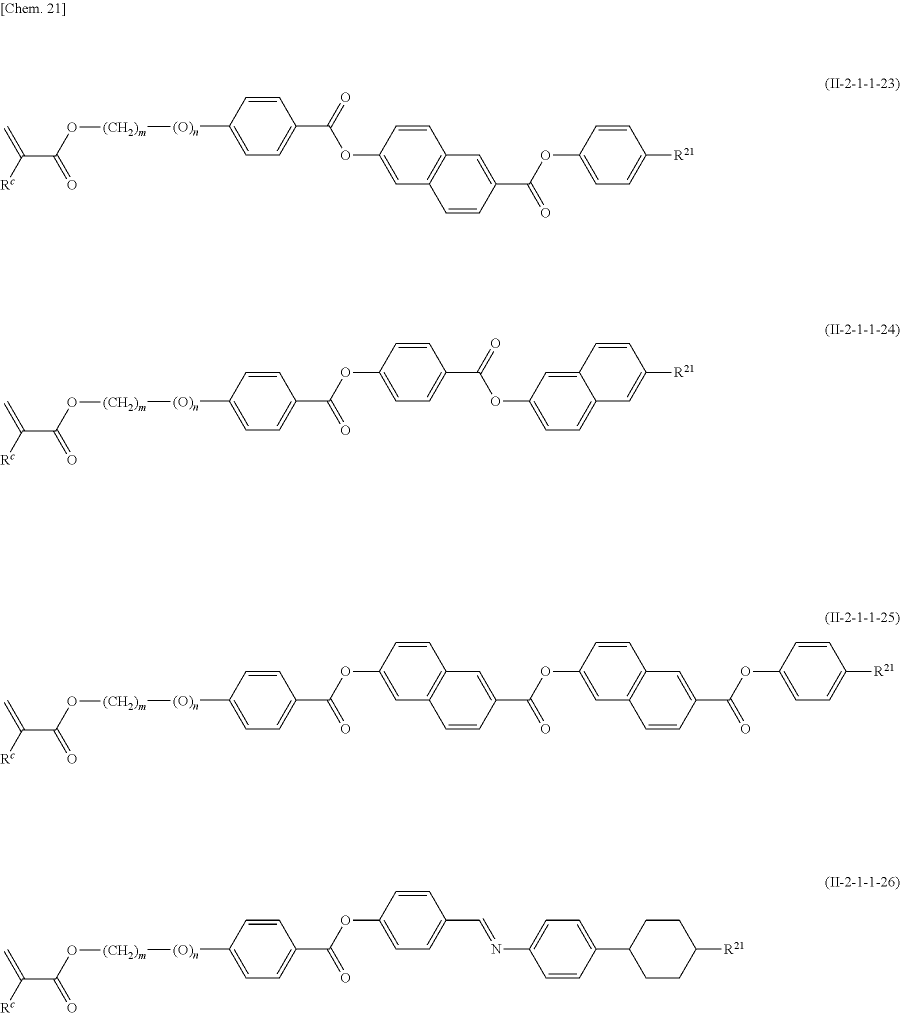

In each of the formulae, R^{c} represents a hydrogen atom or a methyl group; m represents an integer from 0 to 18; n represents 0 or 1; R2′ has the same definition as that in General Formulae (II-2-1-1) to (II-2-1-4); R²¹ preferably represents a linear alkyl or alkenyl group having 1 to 6 carbon atoms, in which a hydrogen atom, a halogen atom, a cyano group, or one —CH₂— is optionally substituted with —O—, —CO—, —COO—, or —OCO—; the cyclic group optionally has, as a substituent, at least one selected from F, Cl, CF₃, OCF₃, a CN group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, and an alkenoyloxy group having 2 to 8 carbon atoms.

The total amount of the monofunctional polymerizable liquid crystal compounds having one polymerizable functional group per molecule is preferably in the range of 0 to 90 mass %, more preferably 0 to 85 mass %, and especially preferably 0 to 80 mass % relative to the total amount of the polymerizable liquid crystal compounds to be used. In terms of orientation in an optically anisotropic body, the lower limit of the amount is preferably 5 mass % or more, and more preferably 10 mass % or more; in terms of the hardness of a coating film, the upper limit is preferably 80 mass % or less, and more preferably 70 mass % or less.

### (Difunctional Polymerizable Liquid Crystal Compound)

Among compounds represented by General Formula (II), a preferred difunctional polymerizable liquid crystal compound having two polymerizable functional groups per molecule is any of compounds represented by General Formula (II-2-2).

[Chem. 22]

P²—(S¹—X¹)_{q1}-MG-(X²—S²)_{q2}—P³ (II-2-2)

In the formula, P², S¹, X¹, q1, MG, X², S², q2, and P³ have the same definitions as those in General Formula (II). Examples of the compound represented by General Formula (II-2-2) include, but are not limited to, compounds represented by General Formulae (II-2-2-1) to (II-2-2-4).

[Chem. 23]

P²—(S¹—X¹)_{q1}—B2-Z2-B3-(X²—S²)_{q2}—P³ (II-2-2-1)

P²—(S¹—X¹)^{q1}—B11-Z11-B2-Z2-B3-(X²—S²)_{q2}P³ (II-2-2-2)

P²—(S¹—X¹)_{q1}—B11-Z11-B2-Z12-B2-Z2-B3-(X²—S²)_{q2}—P³ (II-2-2-3)

P²—(S¹—X¹)_{q4}—B11-Z11-B12-Z12-B13-Z13-B2-Z2-B3-(X²—S²)_{q2}—P³ (II-2-2-4)

In the formulae, P², S¹, X¹, q1, MG, X², S², q2, and P³ have the same definitions as those in General Formula (II); B11, B12, B13, B2, and B3 have the same definitions as B1 to B3 in General Formula (II-b) and may be the same as or different from each other; and Z11, Z12, Z13, and Z2 have the same definitions as Z1 to Z3 in General Formula (II-b) and may be the same as or different from each other.

Among the compounds represented by General Formulae (II-2-2-1) to (II-2-2-4), the compounds represented by General Formulae (II-2-2-2) to (II-2-2-4) and each having three or more ring structures are preferred because using such compounds enables production of an optically anisotropic body having a good orientation and hardness, and the compound represented by General Formula (II-2-2-2) and having three ring structures is especially preferred.

Examples of the compounds represented by General Formulae (II-2-2-1) to (II-2-2-4) include, but are not limited to, compounds represented by Formulae (II-2-2-1-1) to (II-2-2-1-21).

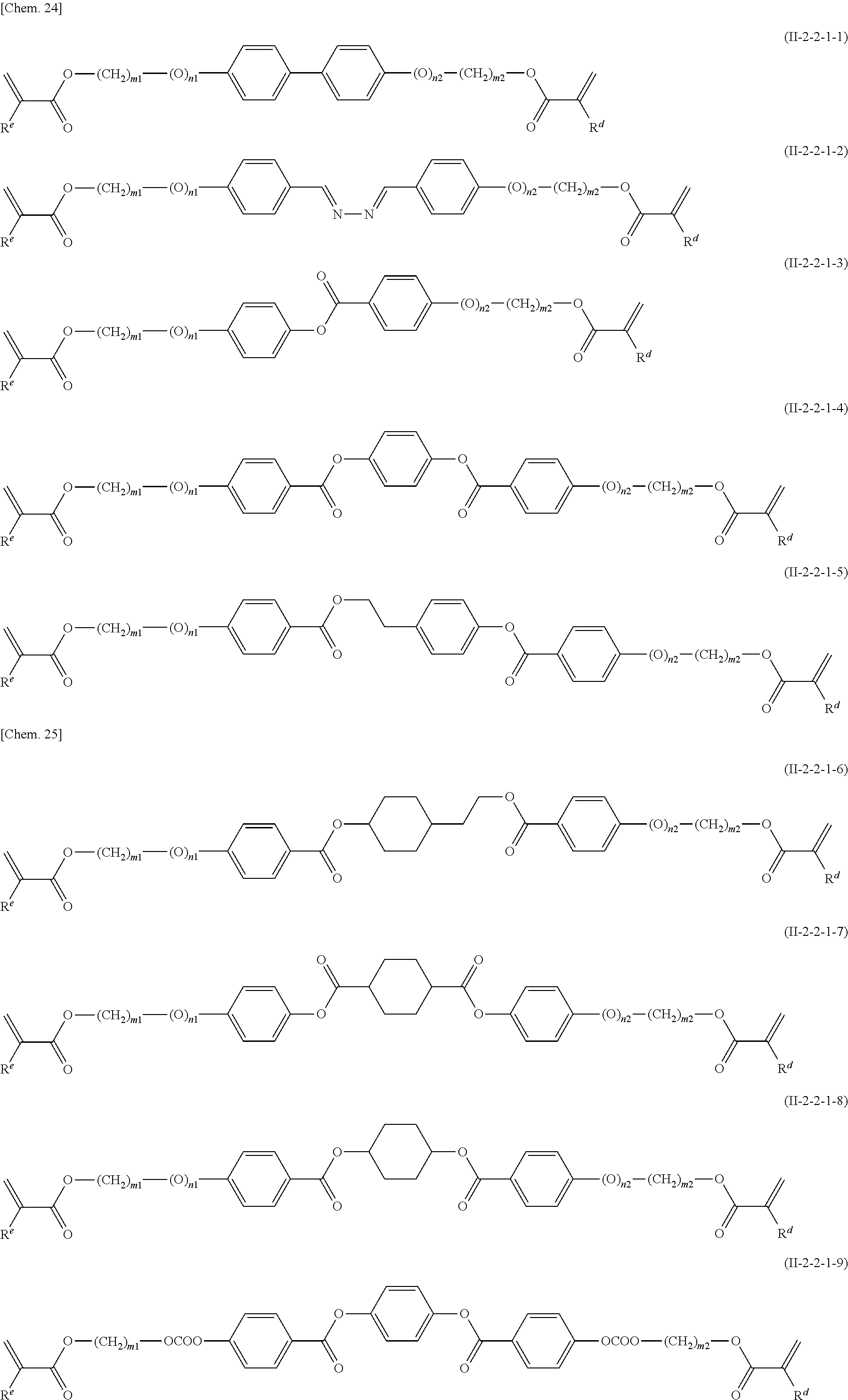

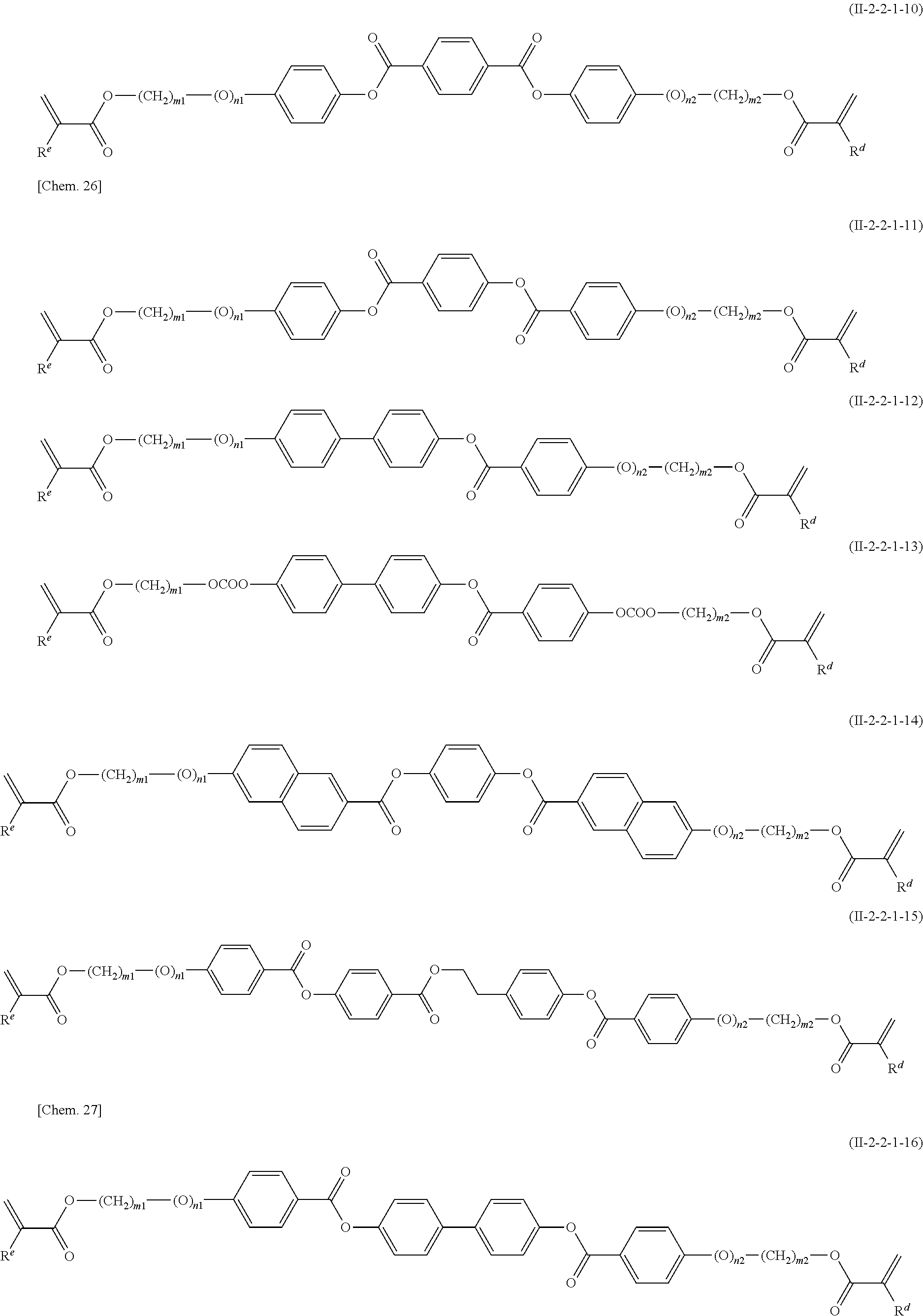

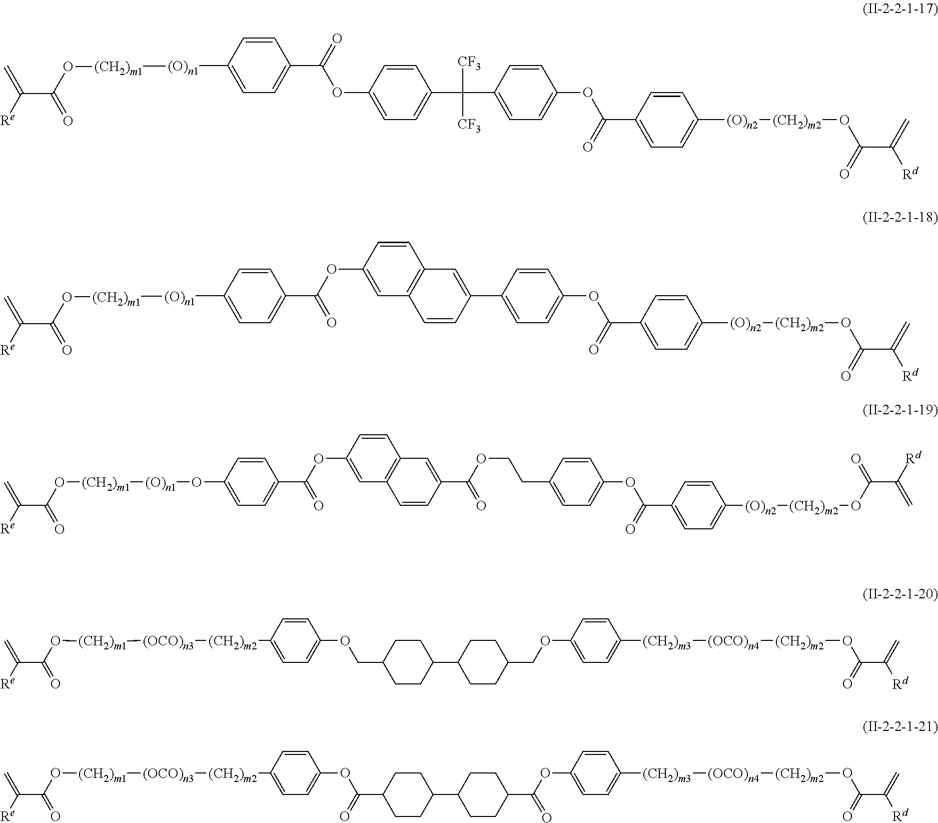

In the formulae, R^{d} and R^{e} each independently represent a hydrogen atom or a methyl group; the cyclic group optionally has, as a substituent, at least one selected from F, Cl, CF₃, OCF₃, a CN group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, and an alkenoyloxy group having 2 to 8 carbon atoms; m1 and m2 each independently represent an integer from 0 to 18; and n1, n2 n3, and n4 each independently represent 0 or 1.

In the compounds represented by Formulae (II-2-2-1-1) to (II-2-2-1-21), specific examples of a compound which is represented by Formula (II-2-2-1-4) and of which the cyclic group has a substituent preferably include compounds represented by Formula (II-2-2-1-4-1).

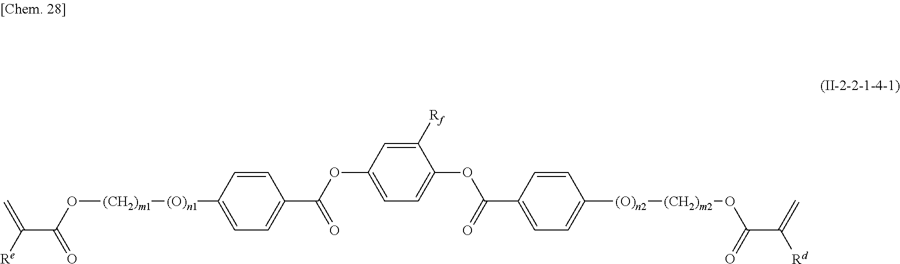

(in the formula, R^{d}, R^{e}, m1, m2, n1, n2, n3, and n4 have the same definitions as those of the compounds represented by Formulae (II-2-2-1-1) to (II-2-2-1-21); and the substituent R_{f} represents an alkyl group having 1 to 8 carbon atoms or an alkoxy group having 1 to 8 carbon atoms)

Among the compounds represented by General Formulae (II-2-2-1-1) to (II-2-2-1-21), the compounds represented by General Formulae (II-2-2-1-4) to (II-2-2-1-14) are preferred because use of these compounds each having three rings enables production of an optically anisotropic body having a good orientation and hardness; the compounds represented by General Formulae (II-2-2-1-4), (II-2-2-1-5), and (II-2-2-1-9) to (II-2-2-1-13) are more preferred; the compounds represented by General Formulae (II-2-2-1-4) and (II-2-2-1-5) are further preferred; and the compound represented by General Formula (II-2-2-1-5) is especially preferred.

At least one liquid crystal compound having two polymerizable functional groups can be used; one to five compounds are preferably used, and two to five compounds are more preferably used.

The total amount of the difunctional polymerizable liquid crystal compounds each having two polymerizable functional groups per molecule is preferably from 10 to 100 mass %, more preferably 15 to 85 mass %, and especially 20 to 80 mass % relative to the total amount of polymerizable liquid crystal compounds to be used. Using the liquid crystal compound having two polymerizable functional groups produces the synergistic effect with the compound (I), which enables production of an optically anisotropic body having an excellent adhesion to a base material. In terms of the hardness of a coating film, the lower limit of the amount is preferably 30 mass % or more, and more preferably 50 mass % or more; in terms of the orientation of an optically anisotropic body, the upper limit of the amount is preferably 85 mass % or less, and more preferably 80 mass % or less.

### (Polyfunctional Polymerizable Liquid Crystal Compound)

A preferred polyfunctional polymerizable liquid crystal compound having tree or more polymerizable functional groups is a compound having three polymerizable functional groups. Among compounds represented by General Formula (II), a preferred polyfunctional polymerizable liquid crystal compound having three polymerizable functional groups per molecule is any of compounds represented by General Formula (II-2-3).

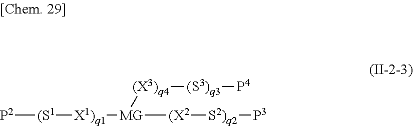

In the formula, P², S¹, X¹, q1, MG, X², S², q2, P³, X³, q4, S³, q3, P⁴ have the same definitions as those in General Formula (II). Examples of the compound represented by General Formula (II-2-3) include, but are not limited to, compounds represented by General Formulae (II-2-3-1) to (II-2-3-8).

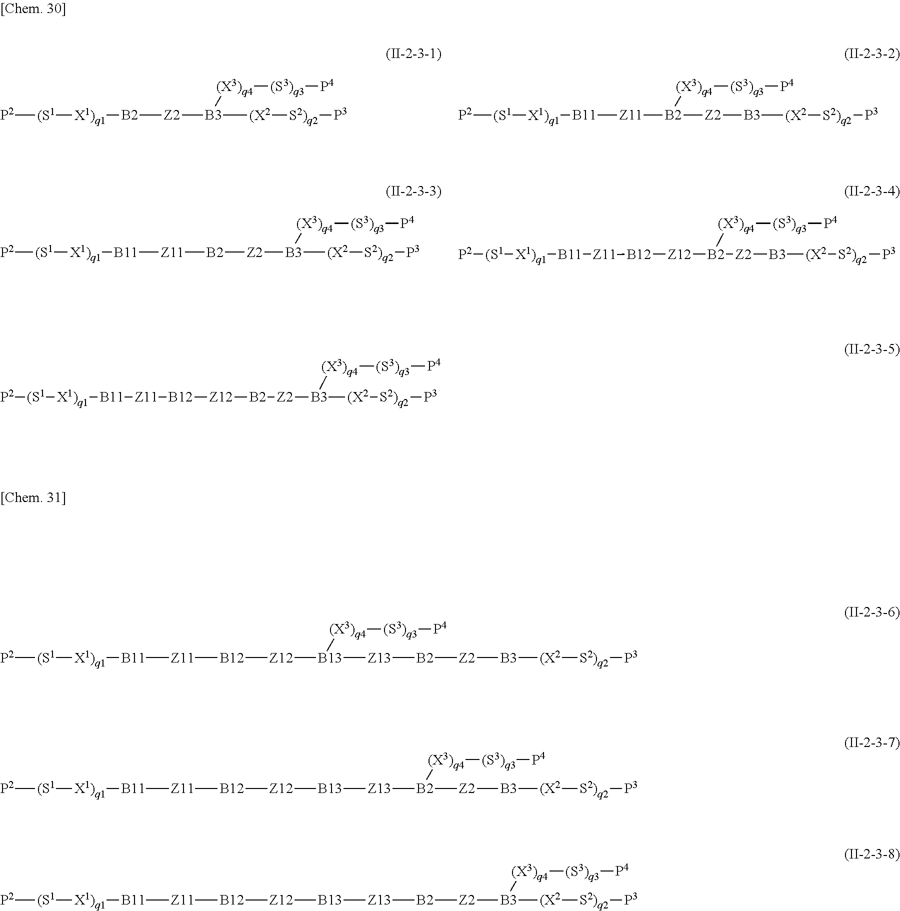

In the formulae, P², S¹, X¹, q1, MG, X², S², q2, P³, X³, q4, S³, q3, and P⁴ have the same definitions as those in General Formula (II);

B11, B12, B13, B2, and B3 have the same definitions as B1 to B3 in General Formula (II-b) and may be the same as or different from each other;
Z11, Z12, Z13, and Z2 have the same definitions as Z1 to Z3 in General Formula (II-b) and may be the same as or different from each other.

Examples of the compounds represented by General Formulae (II-2-3-1) to (II-2-3-8) include, but are not limited to, compounds represented by Formulae (II-2-3-1-1) to (II-2-3-1-6).

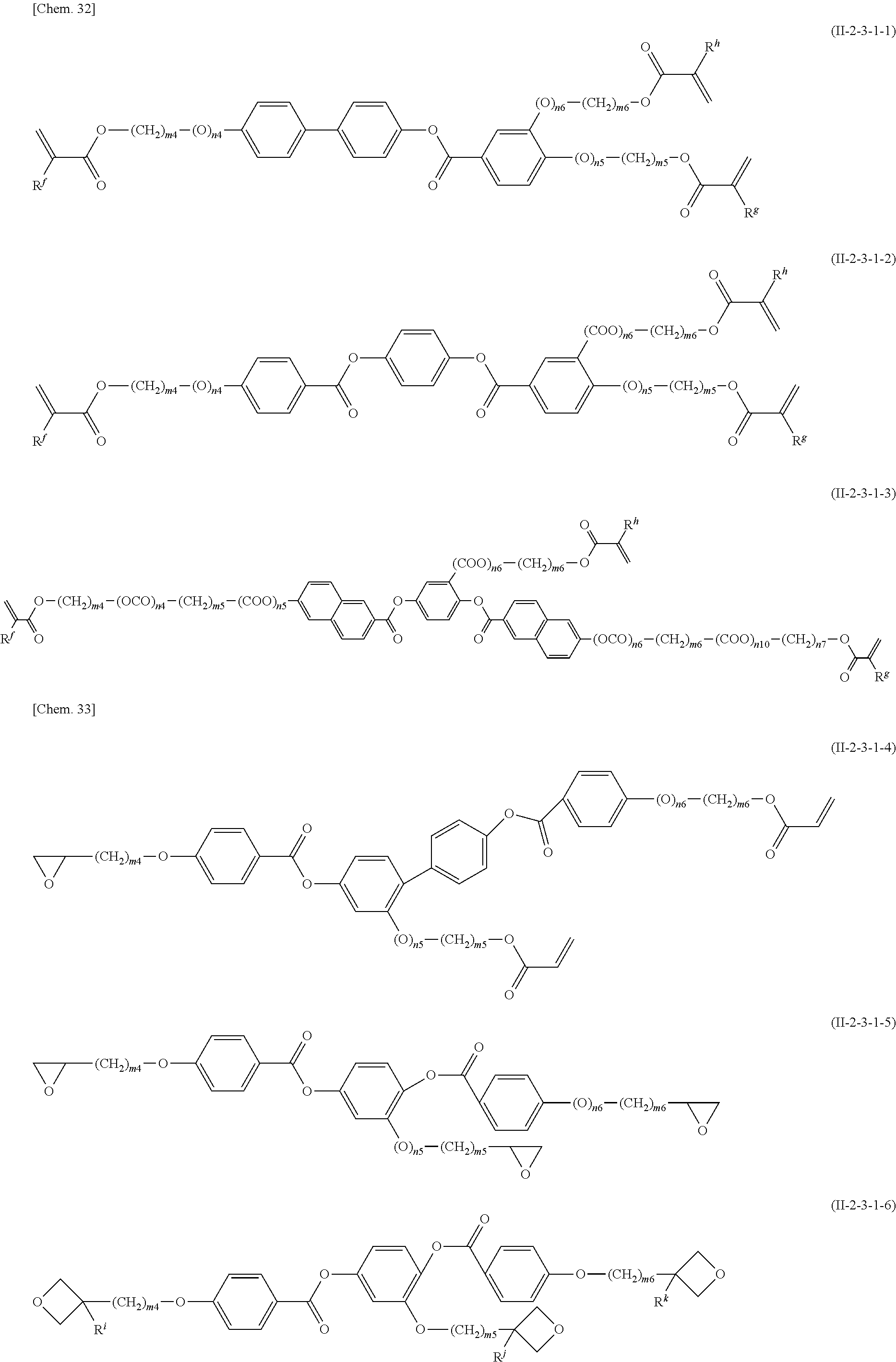

In the formulae, R^{f}, R^{g}, and R^{h} each independently represent a hydrogen atom or a methyl group; Rⁱ, R^{j}, and R^{k} each independently represent a hydrogen atom, a halogen atom, an alkyl group having 1 to 6 carbon atoms, an alkoxy group having 1 to 6 carbon atoms, or a cyano group; in the case where these groups are each an alkyl group having 1 to 6 carbon atoms or an alkoxy group having 1 to 6 carbon atoms, all of them are optionally unsubstituted or substituted with one or more halogen atoms; the cyclic group optionally has, as a substituent, at least one selected from F, Cl, CF₃, OCF₃, a CN group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, and an alkenoyloxy group having 2 to 8 carbon atoms;

m4 to m9 each independently represent an integer from 0 to 18; and n4 to n9 each independently represent 0 or 1.

One or more polyfunctional polymerizable liquid crystal compounds each having three or more polymerizable functional groups can be used.

The total amount of the polyfunctional polymerizable liquid crystal compounds each having three or more polymerizable functional groups per molecule is preferably from 0 to 80 mass %, more preferably 0 to 60 mass %, and especially preferably 0 to 40 mass % relative to the total amount of the polymerizable liquid crystal compounds to be used. In terms of the rigidity of an optically anisotropic body, the lower limit of the amount is preferably 10 mass % or more, more preferably 20 mass % or more, and especially preferably 30 mass % or more; in terms of a reduction in shrinkage on cure, the upper limit thereof is preferably 50 mass % or less, more preferably 35 mass % or less, and especially preferably 20 mass % or less.

### (Combined Use of Polymerizable Liquid Crystal Compounds)

In the polymerizable liquid crystal composition of the present invention, it is preferred that different types of the above-mentioned polymerizable liquid crystal compounds be mixed. Using at least one of the monofunctional polymerizable liquid crystal compounds and at least one of the difunctional polymerizable liquid crystal compounds and/or at least one of the polyfunctional polymerizable liquid crystal compounds in combination is preferred because it enables production of an optically anisotropic body having an enhanced hardness and good adhesion to a base material; using at least one of the monofunctional polymerizable liquid crystal compounds and at least one of the difunctional polymerizable liquid crystal compounds in combination is more preferred. In particular, in the case where an optically anisotropic body produced using the polymerizable liquid crystal composition of the present invention needs to have an enhanced hardness, difunctional polymerizable liquid crystal compounds selected from the compounds represented by Formulae (II-2-2-2) to (II-2-2-4) and having three or more ring structures are preferably used in the form of a mixture of polymerizable liquid crystal compounds, and a mixture of the compounds represented by Formulae (II-2-1-2) and (II-2-2-2) and having three ring structures is especially preferred.

The total amount of the monofunctional polymerizable liquid crystal compound and the difunctional polymerizable liquid crystal compound is preferably in the range of 70 mass % to 100 mass %, and especially preferably 80 mass % to 100 mass % relative to the total amount of the polymerizable liquid crystal compounds to be used.

(Other Liquid Crystal Compounds)

The liquid crystal composition of the present invention may contain a compound containing a mesogenic group that is free from a polymerizable group; and examples of such a compound include compounds used in general liquid crystal devices such as STN (super twisted nematic) liquid crystal devices, TN (twisted nematic) liquid crystal devices, and TFT (thin film transistor) liquid crystal devices.

Specifically, the compound containing a mesogenic group having no polymerizable functional group is preferably any of compounds represented by General Formula (5).

[Chem. 34]

R⁵¹-MG3-R⁵² (5)

MG3 is a mesogenic group or mesogenic supporting group represented by General Formula (5-b).

[Chem. 35]

—Z0^{d}-(A1^{d}-Z1^{d})ₙₑ-A2^{d}-Z2^{d}-A3^{d}-Z3^{d}- (5-b)

(in the formula, A1^{d}, A2^{d}, and A3^{d} each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a benzoselenopheno[3,2-b]selenophene-2,7-diyl group, or a fluorene-2,7-diyl group, and may have, as a substituent, at least one selected from F, Cl, CF₃, OCF₃, a CN group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkenyl group having 2 to 8 carbon atoms, an alkenyloxy group having 2 to 8 carbon atoms, an alkenoyl group having 2 to 8 carbon atoms, and an alkenoyloxy group having 2 to 8 carbon atoms;

Z0^{d}, Z1^{d}, Z2^{d}, and Z3^{d} each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkylene group having 2 to 10 carbon atoms and optionally a halogen atom, or a single bond;
nₑ represents 0, 1, or 2;
R⁵¹ and R⁵² each independently represent a hydrogen atom, a halogen atom, a cyano group, or an alkyl group having 1 to 18 carbon atoms; the alky group is optionally substituted with at least one halogen atom or CN; and in the alkyl group, one CH₂ group or two or more CH₂ groups not adjoining each other are each independently optionally substituted with —O—, —S—, —NH—, —N(CH₃)—, —CO—, —COO—, —OCO—, —OCOO—, —SCO—, —COS—, or —C≡C— such that oxygen atoms are not directly bonded to each other)

Specific examples of such a compound include, but are not limited to, the following compounds.

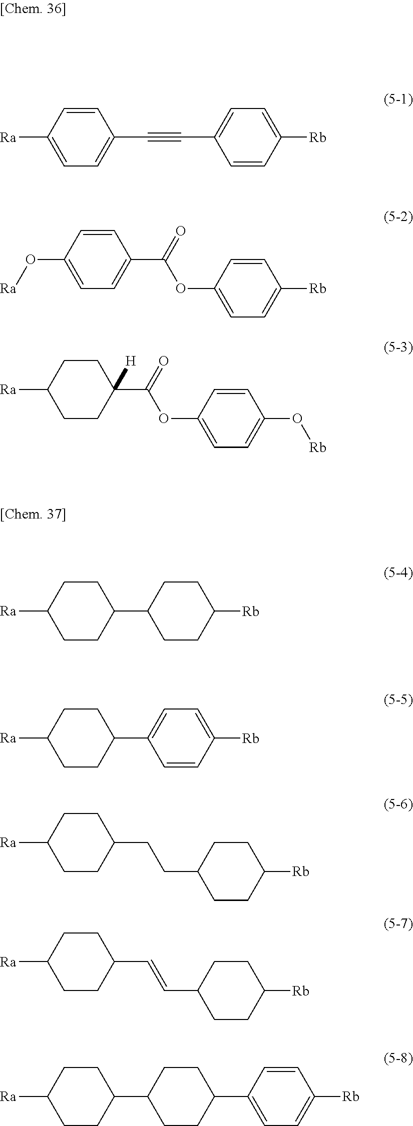

Ra and Rb each independently represent a hydrogen atom, an alkyl group having 1 to 6 carbon atoms, an alkoxy group having 1 to 6 carbon atoms, an alkenyl group having 1 to 6 carbon atoms, or a cyano group; in the case where Ra and Rb are each an alkyl group having 1 to 6 carbon atoms or an alkoxy group having 1 to 6 carbon atoms, all of them may be unsubstituted or substituted with one or more halogen atoms.

The total amount of compounds each containing a mesogenic group is preferably in the range of 0 mass % to 20 mass % relative to the amount of the whole polymerizable liquid crystal composition. In the case where such compounds are used, the total amount is preferably not less than 1 mass %, also preferably not less than 2 mass %, and also preferably not less than 5 mass %; in addition, it is preferably not more than 15 mass %, and also preferably not more than 10 mass %.

(Other Components)

(Chiral Compounds)

In addition to the polymerizable compound represented by General Formula (II), the polymerizable liquid crystal composition of the present invention can contain a polymerizable chiral compound that may be liquid crystalline or non-liquid crystalline.

The polymerizable chiral compound to be used in the present invention preferably contains at least one polymerizable functional group. Examples of such a compound include polymerizable chiral compounds containing chiral sugars, such as isosorbide, isomannite, and glucoside, and also having a rigid moiety, such as a 1,4-phenylene group or 1,4-cyclohexlene group, and a polymerizable functional group, such as a vinyl group, an acryloyl group, a (meth)acryloyl group, or a maleimide group, as disclosed in Japanese Unexamined Patent Application Publication Nos. 11-193287, 2001-158788, 2007-269639, 2007-269640, and 2009-84178, and Japanese Unexamined Patent Application Publication (Translation of PCT Application) No. 2006-52669; polymerizable chiral compounds formed of terpenoid derivatives as disclosed in Japanese Unexamined Patent Application Publication No. 8-239666; polymerizable chiral compounds each having a spacer with a mesogenic group and a chiral moiety as disclosed in, for example, NATURE VOL. 35, 467 to 469 (issued on Nov. 30, 1995) and NATURE VOL. 392, 476 to 479 (issued on Apr. 2, 1998); and polymerizable chiral compounds containing a binaphthyl group as disclosed in Japanese Unexamined Patent Application Publication (Translation of PCT Application) No. 2004-504285 and Japanese Unexamined Patent Application Publication No. 2007-248945. Of these, chiral compounds with large helical twisting power (HTP) are preferred in the polymerizable liquid crystal composition of the present invention.
The amount of the polymerizable chiral compound needs to be appropriately adjusted on the basis of the helical twisting power of the compound and is preferably from 0 to 25 mass %, more preferably 0 to 20 mass %, and especially preferably 0 to 15 mass % in the polymerizable liquid crystal composition. Examples of general formulae that represent the polymerizable chiral compound include, but are not limited to, General Formulae (3-1) to (3-4).

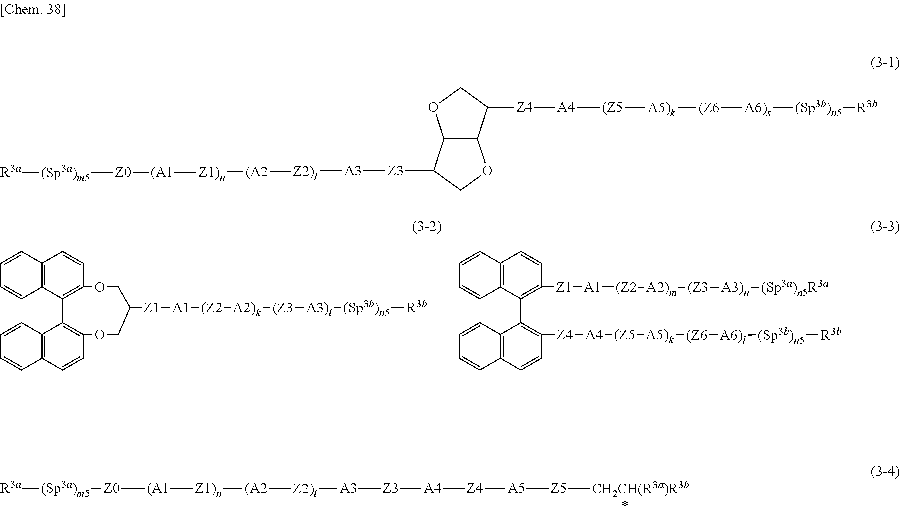

In the formulae, Sp^{3a} and Sp^{3b} each independently represent an alkylene group having 0 to 18 carbon atoms; the alkylene group is optionally substituted with at least one halogen atom, CN group, or alkyl group having 1 to 8 carbon atoms and a polymerizable functional group; one CH₂ group or two or more CH₂ groups not adjoining each other in the alkylene group are each independently optionally substituted with —O—, —S—, —NH—, —N(CH₃)—, —CO—, —COO—, —OCO—, —OCOO—, —SCO—, —COS—, or —C≡C— such that oxygen atoms are not directly bonded to each other;

A1, A2, A3, A4, and A5 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronapthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group; n, 1, and k each independently represent 0 or 1 and give the relationship of 0 S n+1+k≦3;
Z0, Z1, Z2, Z3, Z4, Z5, and Z6 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms and optionally a halogen atom, or a single bond;
n5 and m5 each independently represent 0 or 1;
R^{3a} and R^{3b} each represent a hydrogen atom, a halogen atom, a cyano group, or an alkyl group having 1 to 18 carbon atoms; the alkyl group is optionally substituted with at least one halogen atom or CN; one CH₂ group or two or more CH₂ groups not adjoining each other in the alkyl group are each independently optionally substituted with —O—, —S—, —NH—, —N(CH₃)—, —CO—, —COO—, —OCO—, —OCOO—, —SCO—, —COS—, or —C≡C— such that oxygen atoms are not directly bonded to each other;
alternatively, R^{3a} and R^{3b} are represented by General Formula (3-a)

[Chem. 39]

—P^{3a} (3-a)

(in the formula, P^{3a} represents a polymerizable functional group, and Sp^{3a} has the same meaning as Sp¹)

P^{3a} preferably represents a substituent selected from polymerizable groups represented by Formulae (P-1) to (P-20).

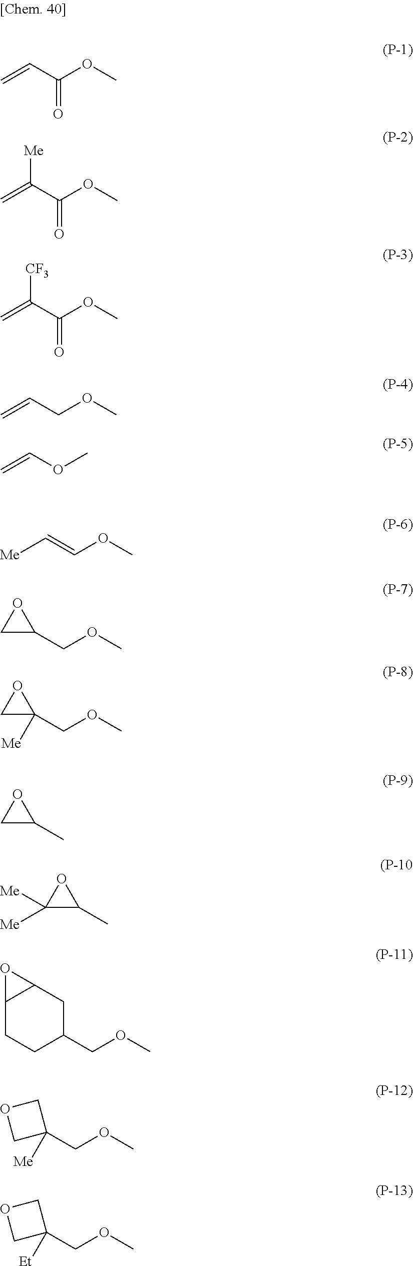

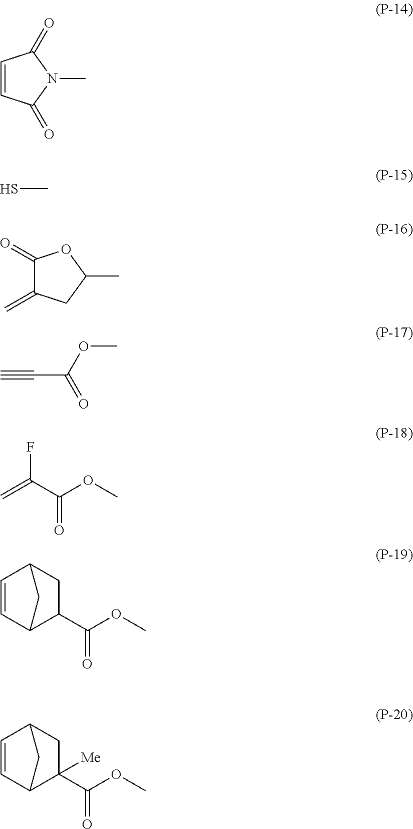

Of these polymerizable functional groups, the groups represented by Formula (P-1) and Formulae (P-2), (P-7), (P-12), and (P-13) are preferred in order to improve polymerizability and storage stability; and the groups represented by Formulae (P-1), (P-7), and (P-12) are more preferred.

Specific examples of the polymerizable chiral compound include, but are not limited to, compounds (3-5) to (3-25).

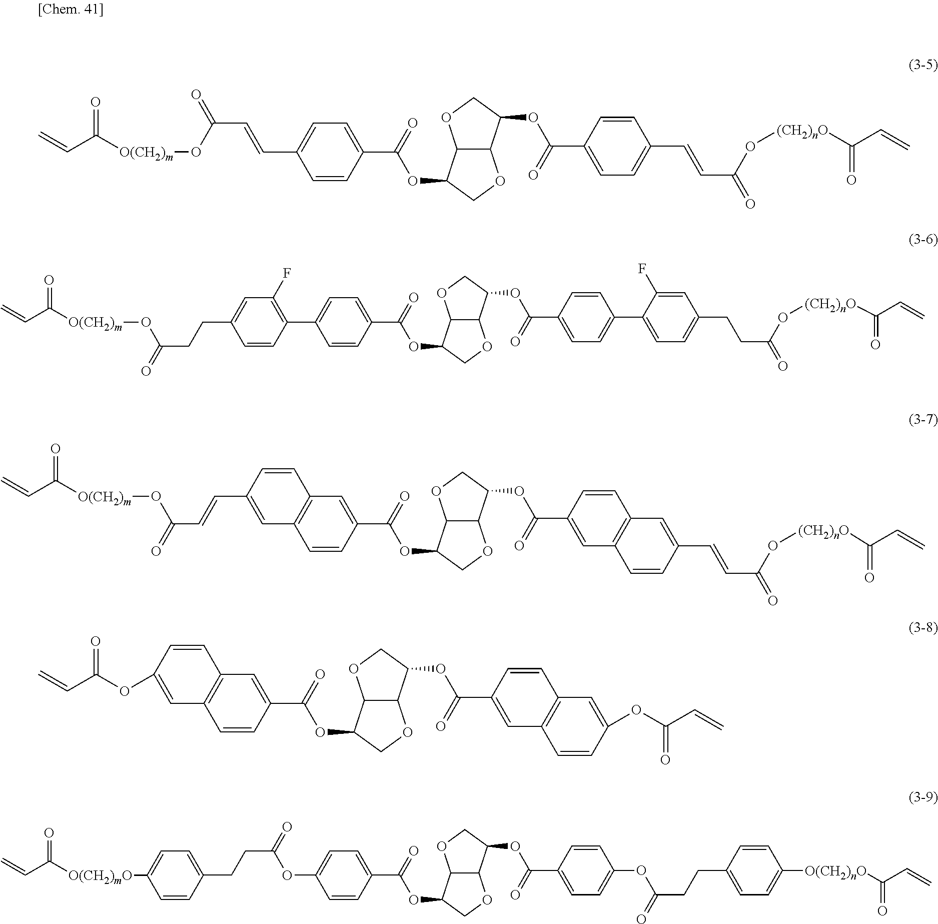

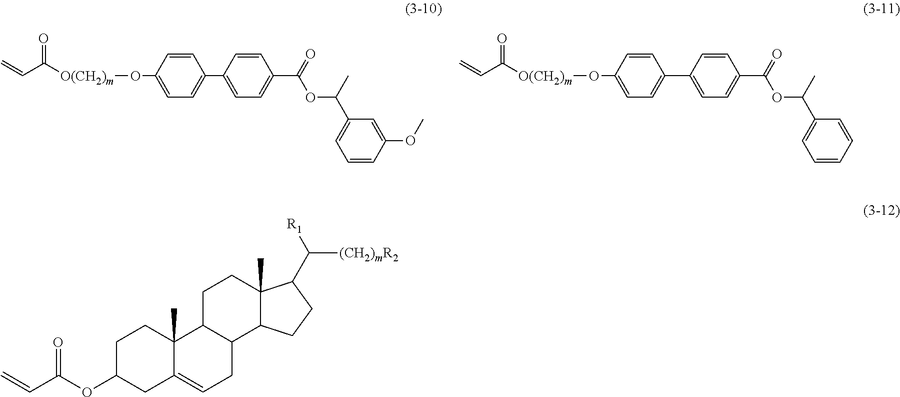

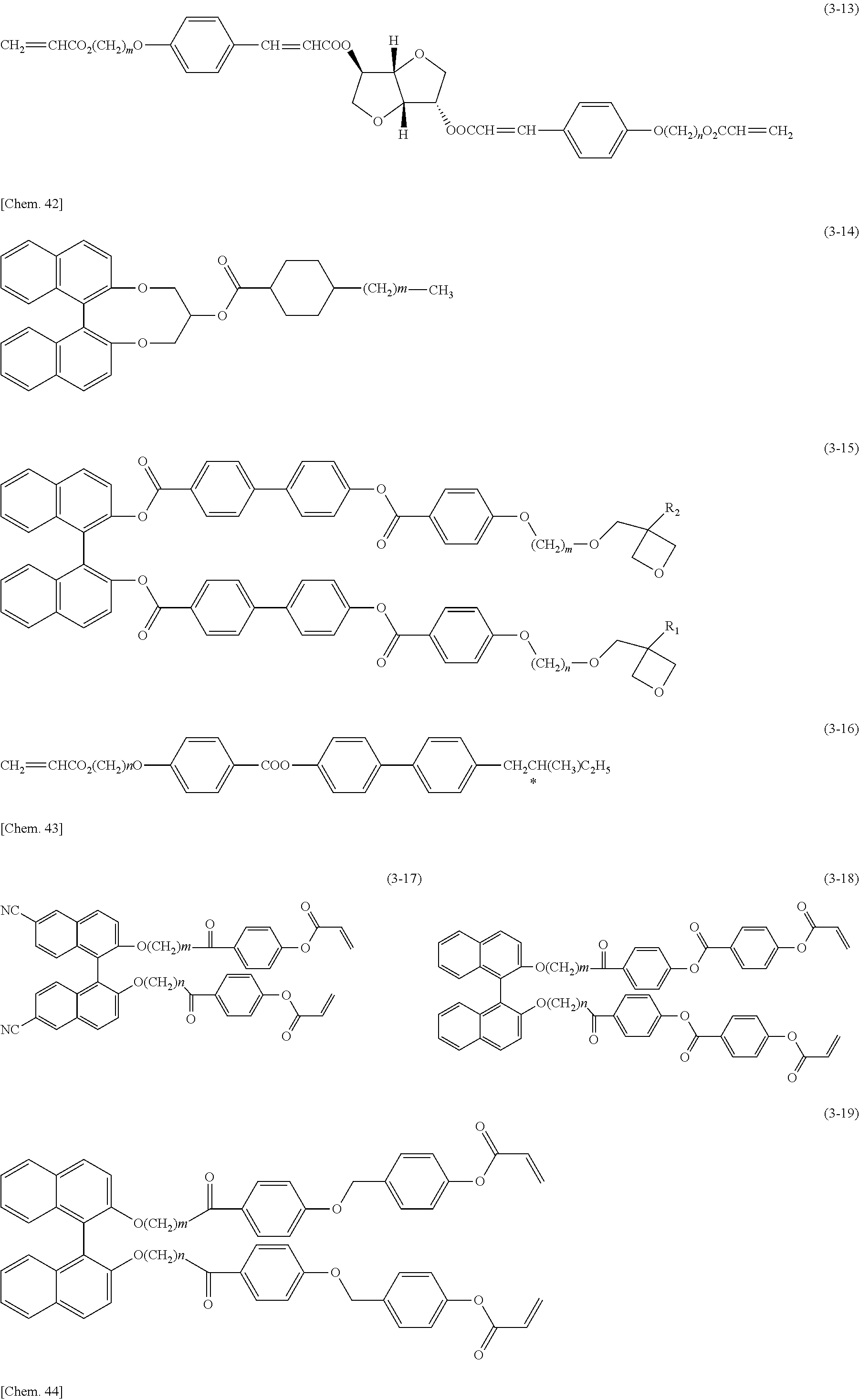

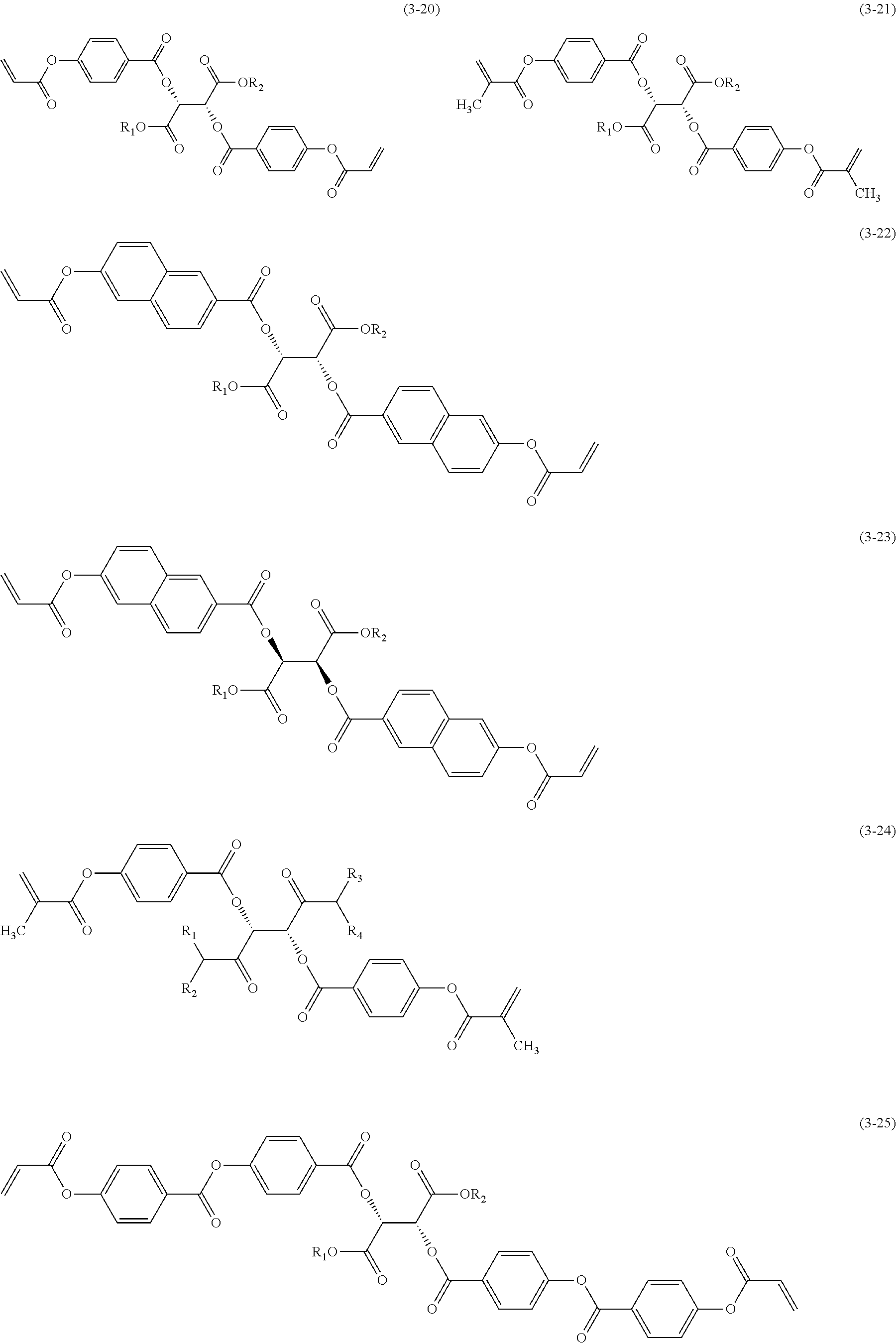

In the formulae, m, n, k, and l each independently In the formulae, m, n, k, and l each independently represent an integer from 1 to 18; and R₁ to R₄ each independently represent a hydrogen atom, an alkyl group having 1 to 6 carbon atoms, an alkoxy group having 1 to 6 carbon atoms, a carboxy group, or a cyano group. In the case where these groups are alkyl groups each having 1 to 6 carbon atoms or alkoxy groups each having 1 to 6 carbon atoms, each of them may have no substituent or may be substituted with one or more halogen atoms.

### (Polymerizable Discotic Compound)

In addition to the polymerizable compound represented by General Formula (II), the polymerizable liquid crystal composition of the present invention can contain a polymerizable discotic compound that may be liquid crystalline or non-liquid crystalline.
The polymerizable discotic compound used in the present invention preferably has at least one polymerizable functional group. Examples of such a compound include polymerizable compounds disclosed in Japanese Unexamined Patent Application Publication Nos. 7-281028, 7-287120, 7-333431, and 8-27284.
The amount of the polymerizable discotic compound needs to be appropriately adjusted on the basis of the type of the compound and is preferably from 0 to 10 mass % in the polymerizable liquid crystal composition.
Examples of general formulae that represent the polymerizable discotic compound include, but are not limited to, General Formulae (4-1) to (4-3).

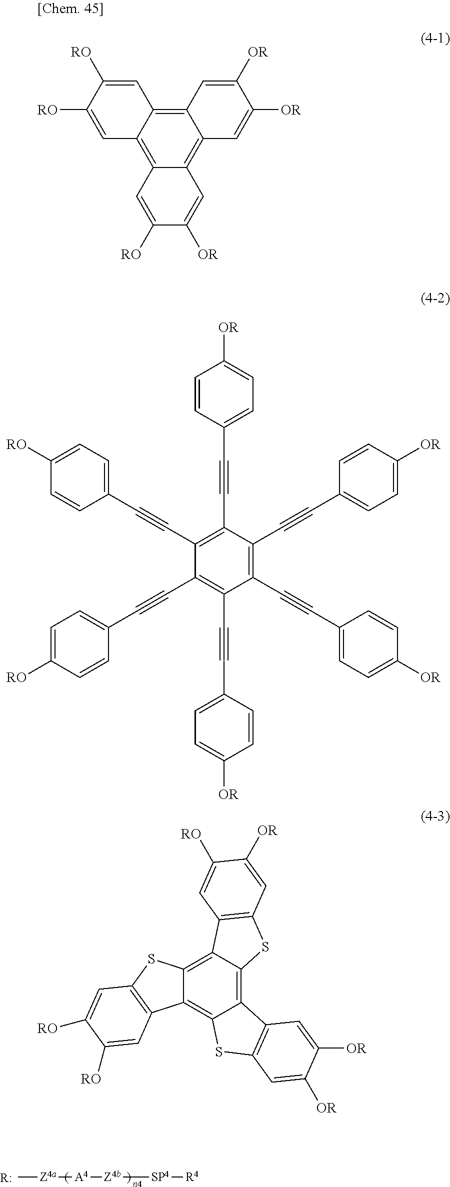

In the formula, Sp⁴ represents an alkylene group having 0 to 18 carbon atoms; the alkylene group is optionally substituted with at least one halogen atom, CN group, or alkyl group having 1 to 8 carbon atoms and a polymerizable functional group; one CH₂ group or two or more CH₂ groups not adjoining each other in the alkylene group are each independently optionally substituted with —O—, —S—, —NH—, —N(CH₃)—, —CO—, —COO—, —OCO—, —OCOO—, —SCO—, —COS—, or —C≡C— such that oxygen atoms are not directly bonded to each other;

A⁴ represents a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronapthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group;
n5 represents 0 or 1,

Z^{4a} represents —CO—, —CH₂CH₂—, —CH₂O—, —CH═CH—, —CH═CHCOO—, —CH₂CH₂COO—, —CH₂CH₂OCO—, —COCH₂CH₂—, an alkyl group having 2 to 10 carbon atoms and optionally a halogen atom, or a single bond;

Z^{4b} represents —COO—, —OCO—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, —OCOO—, an alkyl group having 2 to 10 carbon atoms and optionally a halogen atom, or a single bond;
R⁴ represents a hydrogen atom, a halogen atom, a cyano group, and an alkyl group having 1 to 18 carbon atoms; the alkyl group is optionally substituted with at least one halogen atom or CN; one CH₂ group or two or more CH₂ groups not adjoining each other in the alkyl group are each independently optionally substituted with —O—, —S—, —NH—, —N(CH₃)—, —CO—, —COO—, —OCO—, —OCOO—, —SCO—, —COS—, or —C≡C— such that oxygen atoms are not directly bonded to each other;
   alternatively, R⁴ is represented by General Formula (4-a)

[Chem. 46]

—P^{4a} (4-a)

(in the formula, P^{4a} represents a polymerizable functional group, and Sp^{3a} has the same meaning as Sp¹)

P^{4a} preferably represents a substituent selected from polymerizable groups represented by Formulae (P-1) to (P-20).

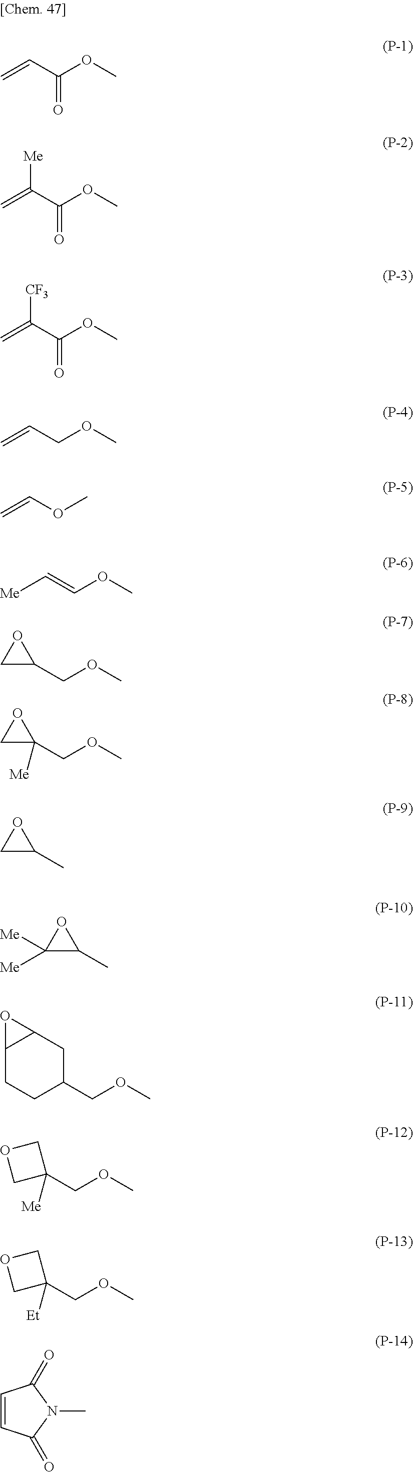

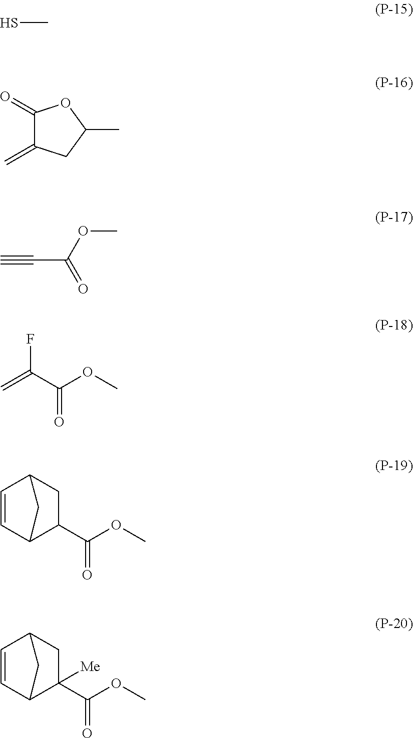

Of these polymerizable functional groups, the groups represented by Formula (P-1) and Formulae (P-2), (P-7), (P-12), and (P-13) are preferred in order to improve polymerizability and storage stability; and the groups represented by Formulae (P-1), (P-7), and (P-12) are more preferred.

Specific examples of the polymerizable discotic compound include, but are not limited to, compounds (4-4) to (4-8).

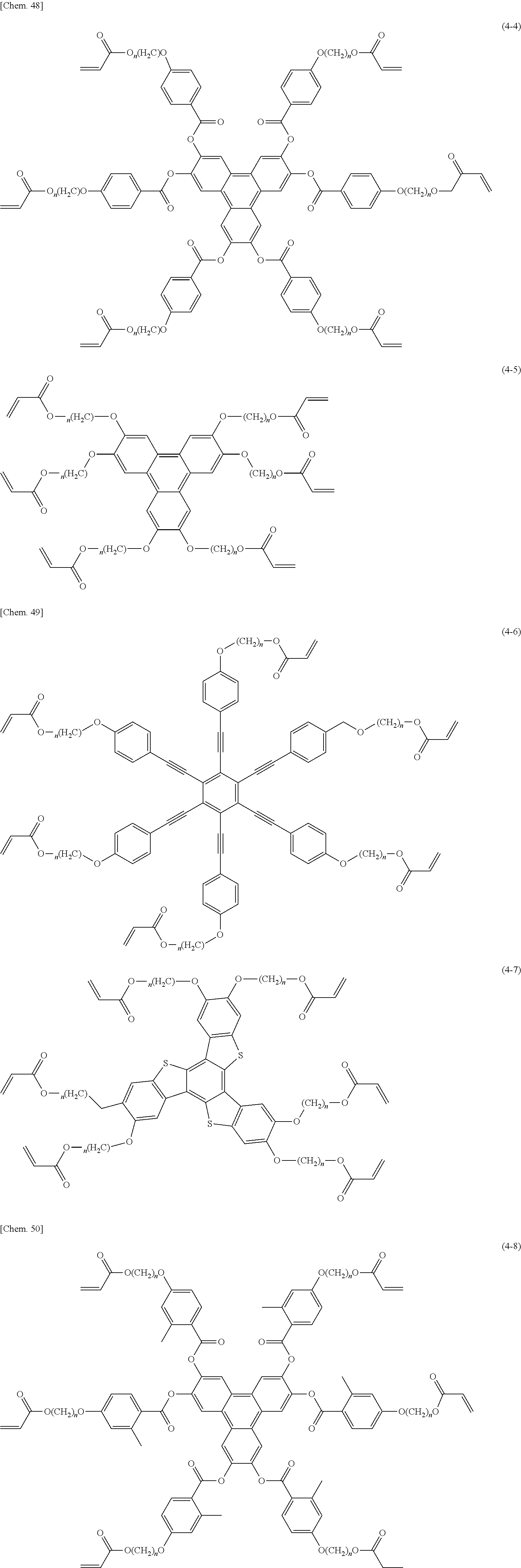

In the formulae, n represents an integer of 1 to 18.

### (Organic Solvent)

The polymerizable liquid crystal composition of the present invention may contain an organic solvent. An organic solvent to be used is not particularly limited but preferably an organic solvent that dissolves polymerizable compounds well and that can be dried at not more than 100° C. Examples of such a solvent include aromatic hydrocarbons such as toluene, xylene, cumene, and mesitylene; ester solvents such as methyl acetate, ethyl acetate, propyl acetate, and butyl acetate; ketone solvents such as methyl ethyl ketone, methyl isobutyl ketone, cyclohexanone, and cyclopentanone; ether solvents such as tetrahydrofuran, 1,2-dimethoxyethane, and anisole; amide solvents such as N,N-dimethylformamide and N-methyl-2-pyrrolidone; and propylene glycol monomethyl ether acetate, diethylene glycol monomethyl ether acetate, γ-butyrolactone, and chlorobenzene. These may be used alone or in combination; at least one of ketone solvents, ether solvents, ester solvents, and aromatic hydrocarbon solvents is preferably used in terms of solution stability.

The composition used in the present invention can be applied to a substrate when it is in the form of a solution in the organic solvent. The proportion of the organic solvent used in the polymerizable liquid crystal composition is not particularly limited provided that the state of the coating is not significantly impaired; the total amount of organic solvents contained in the polymerizable liquid crystal composition is preferably in the range of 10 to 95 mass %, more preferably 12 to 90 mass %, and especially preferably 15 to 85 mass %.

In order to uniformly dissolve the polymerizable liquid crystal composition in the organic solvent, stirring under heating is preferably carried out. The temperature in the stirring under heating may be appropriately adjusted on the basis of the solubility of a composition, which is to be used, in the organic solvent; in terms of productivity, the temperature is preferably from 15° C. to 110° C., more preferably 15° C. to 105° C., further preferably 15° C. to 100° C., and especially preferably 20° C. to 90° C.

In a process for adding the solvent, agitation and mixing is preferably performed with a dispersing agitator. Specific examples of a usable dispersing agitator include a disper; a disperser having an agitating blade, such as a turbine blade or a propeller; a paint shaker; a planetary stirring machine; a shaking apparatus; a shaker; and a rotary evaporator. An ultrasonic radiation apparatus can be also used.

It is preferred that the rotational speed for the agitation in the process for adding the solvent be properly adjusted on the basis of the type of an agitator to be used. The rotational speed for the agitation is preferably from 10 rpm to 1000 rpm, more preferably 50 rpm to 800 rpm, and especially preferably 150 rpm to 600 rpm in order to produce a uniform solution of polymerizable liquid crystal composition.

### (Polymerization Inhibitor)

The polymerizable liquid crystal composition of the present invention preferably contains a polymerization inhibitor. Examples of the polymerization inhibitor include phenolic compounds, quinone compounds, amine compounds, thioether compounds, and nitroso compounds.

Examples of the phenolic compounds include p-methoxyphenol, cresol, t-butyl catechol, 3,5-di-t-butyl-4-hydroxytoluene, 2,2′-methylenebis(4-methyl-6-t-butylphenol), 2,2′-methylenebis(4-ethyl-6-t-butylphenol), 4,4′-thiobis(3-methyl-6-t-butylphenol), 4-methoxy-1-naphthol, and 4,4′-dialkoxy-2,2′-bi-1-naphthol.

Examples of the quinone compounds include hydroquinone, methyl hydroquinone, tert-butyl hydroquinone, p-benzoquinone, methyl-p-benzoquinone, tert-butyl-p-benzoquinone, 2,5-diphenylbenzoquinone, 2-hydroxy-1,4-naphthoquinone, 1,4-naphthoquinone, 2,3-dichloro-1,4-naphthoquinone, anthraquinone, and diphenoquinone.

Examples of the amine compounds include p-phenylenediamine, 4-aminodiphenylamine, N.N′-diphenyl-p-phenylenediamine, N-i-propyl-N′-phenyl-p-phenylenediamine, N-(1,3-dimethylbutyl)-N′-phenyl-p-phenylenediamine, N.N′-di-2-naphthyl-p-phenylenediamine, diphenylamine, N-phenyl-p-naphthylamine, 4.4′-dicumyl-diphenylamine, and 4.4′-dioctyl-diphenylamine.

Examples of the thioether compounds include phenothiazine and distearyl thiodipropionate.

Examples of the nitroso compounds include N-nitrosodiphenylamine, N-nitrosophenylnaphthylamine, N-nitrosodinaphthylamine, p-nitrosophenol, nitrosobenzene, p-nitrosodiphenylamine, α-nitroso-β-naphthol, N,N-dimethyl p-nitrosoaniline, p-nitrosodiphenylamine, p-nitrondimethylamine, p-nitron-N,N-diethylamine, N-nitrosoethanolamine, N-nitrosodi-n-butylamine, N-nitroso-N-n-butyl-4-butanolamine, N-nitroso-diisopropanolamine, N-nitroso-N-ethyl-4-butanolamine, 5-nitroso-8-hydroxyquinoline, N-nitrosomorpholine, an N-nitroso-N-phenylhydroxylamine ammonium salt, nitrosobenzene, 2,4,6-tri-tert-butylnitronbenzene, N-nitroso-N-methyl-p-toluenesulfonamide, N-nitroso-N-ethylurethane, N-nitroso-N-n-propylurethane, 1-nitroso-2-naphthol, 2-nitroso-1-naphthol, sodium 1-nitroso-2-naphthol-3,6-sulfonate, sodium 2-nitroso-1-naphthol-4-sulfonate, 2-nitroso-5-methylaminophenol hydrochloride, and 2-nitroso-5-methylaminophenol hydrochloride.

The amount of the polymerization inhibitor is preferably in the range of 0.01 to 1.0 mass %, and more preferably 0.05 to 0.5 mass % relative to the polymerizable liquid crystal composition.

### (Antioxidant)

In order to enhance the stability of the polymerizable liquid crystal composition of the present invention, an antioxidant or another material is preferably used. Examples of such a compound include hydroquinone derivatives, nitrosamine polymerization inhibitors, and hindered phenol antioxidants. Specific examples thereof include tert-butylhydroquinone; methylhydroquinone; “Q-1300” and “Q-1301” manufactured by Wako Pure Chemical Industries, Ltd.; and “IRGANOX 1010”, “IRGANOX 1035”, “IRGANOX 1076”, “IRGANOX 1098”, “IRGANOX 1135”, “IRGANOX 1330”, “IRGANOX 1425”, “IRGANOX 1520”, “IRGANOX 1726”, “IRGANOX 245”, “IRGANOX 259”, “IRGANOX 3114”, “IRGANOX 3790”, “IRGANOX 5057”, and “IRGANOX 565” manufactured by BASF SE.

The amount of the antioxidant is preferably from 0.01 to 2.0 mass %, and more preferably 0.05 to 1.0 mass % relative to the polymerizable liquid crystal composition.

### (Photopolymerization Initiator)

The polymerizable liquid crystal composition of the present invention preferably contains a photopolymerization initiator. At least one photopolymerization initiator is preferably used. Specific Examples thereof include “Irgacure 651”, “Irgacure 184”, “Irgacure 907”, “Irgacure 127”, “Irgacure 369”, “Irgacure 379”, “Irgacure 819”, “Irgacure 2959”, “Irgacure 1800”, “Irgacure 250”, “Irgacure 754”, “Irgacure 784”, “Irgacure OXE01”, “Irgacure OXE02”, “Lucirin TPO”, “Darocur 1173”, and “Darocur MBF” manufactured by BASF Japan Ltd.; “Esacure 1001M”, “Esacure KIP150”, “SpeedCure BEM”, “SpeedCure BMS”, “SpeedCure MBP”, “SpeedCure PBZ”, “SpeedCure ITX”, “SpeedCure DETX”, “SpeedCure EBD”, “SpeedCure MBB”, and “SpeedCure BP” manufactured by Lambson Limited; “KAYACURE DMBI” manufactured by Nippon Kayaku Co., Ltd.; “TAZ-A” manufactured by Nihon SiberHegner K.K. (current DKSH Japan K.K); and “ADEKA OPTOMER SP-152”, “ADEKA OPTOMER SP-170”, “ADEKA OPTOMER N-1414”, “ADEKA OPTOMER N-1606”, “ADEKA OPTOMER N-1717”, and “ADEKA OPTOMER N-1919” manufactured by ADEKA CORPORATION.

The amount of the photopolymerization initiator to be used is preferably in the range of 0.1 to 10 mass %, and especially preferably 0.5 to 7 mass % relative to the polymerizable liquid crystal composition. The photopolymerization initiators may be used alone or in combination, and a sensitizer or another material may be additionally used.

### (Thermal Polymerization Initiator)

In the polymerizable liquid crystal composition of the present invention, the photopolymerization initiator can be used in combination with a thermal polymerization initiator. Specific examples of the thermal polymerization initiator include “V-40” and “VF-096” manufactured by Wako Pure Chemical Industries, Ltd. and “PERHEXYL D” and “PERHEXYL I” manufactured by Nippon Oil & Fats Co., Ltd. (current NOF CORPORATION).

The amount of the thermal polymerization initiator to be used is preferably in the range of 0.1 to 10 mass %, and especially preferably 0.5 to 5 mass % relative to the polymerizable liquid crystal composition. The thermal polymerization initiators may be used alone or in combination.

### (Surfactant)

The polymerizable liquid crystal composition of the present invention may contain at least one surfactant in order to reduce unevenness in the thickness of an optically anisotropic body formed thereof. Examples of usable surfactants include alkyl carboxylates, alkyl phosphates, alkyl sulfonates, fluoroalkyl carboxylates, fluoroalkyl phosphates, fluoroalkyl sulfonates, polyoxyethylene derivatives, fluoroalkyl ethylene oxide derivatives, polyethylene glycol derivatives, alkylammonium salts, and fluoroalkylammonium salts. In particular, fluorine-containing surfactants are preferred. Specific examples thereof include “MEGAFAC F-251”, “MEGAFACF-444”, “MEGAFAC F-477”, “MEGAFAC F-510”, “MEGAFAC F-552”, “MEGAFAC F-553”, “MEGAFAC F-554”, “MEGAFAC F-555”, “MEGAFACF-556”, “MEGAFAC F-557”, “MEGAFAC F-558”, “MEGAFAC F-559”, “MEGAFAC F-560”, “MEGAFAC F-561”, “MEGAFAC F-562”, “MEGAFAC F-563”, “MEGAFAC F-565”, “MEGAFAC F-567”, “MEGAFAC F-568”, “MEGAFAC F-569”, “MEGAFAC F-570”, “MEGAFAC F-571”, “MEGAFAC R-40”, “MEGAFAC R-41”, “MEGAFAC R-43”, “MEGAFAC R-94”, “MEGAFAC RS-72-K”, “MEGAFAC RS-75”, “MEGAFAC RS-76-E”, and “MEGAFAC RS-90” (each manufactured by DIC Corporation);

“Ftergent 100”, “Ftergent 100C”, “Ftergent 110”, “Ftergent 150”, “Ftergent 150CH”, “Ftergent A”, “Ftergent 100A-K”, “Ftergent 501”, “Ftergent 300”, “Ftergent 310”, “Ftergent 320”, “Ftergent 400SW”, “FTX-400P”, “Ftergent 251”, “Ftergent 215M”, “Ftergent 212 MH”, “Ftergent 250”, “Ftergent 222F”, “Ftergent 212D”, “FTX-218”, “FTX-209F”, “FTX-213F”, “FTX-233F”, “Ftergent 245F”, “FTX-208G”, “FTX-240G”, “FTX-260D”, “FTX-220D”, “FTX-230D”, “FTX-240D”, “FTX-207S”, “FTX-211S”, “FTX-220S”, “FTX-230S”, “FTX-750FM”, “FTX-730FM”, “FTX-730FL”, “FTX-710FS”, “FTX-710FM”, “FTX-710FL”, “FTX-750LL”, “FTX-730LS”, “FTX-730LM”, “FTX-730LL”, and “FTX-710LL” (each manufactured by NEOS COMPANY LIMITED); “BYK-300”, “BYK-302”, “BYK-306”, “BYK-307”, “BYK-310”, “BYK-315”, “BYK-320”, “BYK-322”, “BYK-323”, “BYK-325”, “BYK-330”, “BYK-331”, “BYK-333”, “BYK-337”, “BYK-340”, “BYK-344”, “BYK-3440”, “BYK-370”, “BYK-375”, “BYK-377”, “BYK-350”, “BYK-352”, “BYK-354”, “BYK-355”, “BYK-356”, “BYK-358N”, “BYK-361N”, “BYK-357”, “BYK-390”, “BYK-392”, “BYK-UV3500”, “BYK-UV3510”, “BYK-UV3570”, and “BYK-Silclean 3700” (each manufactured by BYK Japan KK);
“TEGO Rad 2100”, “TEGO Rad 2200N”, “TEGO Rad 2250”, “TEGO Rad 2300”, “TEGO Rad 2500”, “TEGO Rad 2600”, and “TEGO Rad 2700” (each manufactured by Evonik Tego Chemie); and “N215”, “N535”, “N605K”, and “N935” (each manufactured by Solvay Solexis).

The amount of the surfactant is preferably from 0.01 to 2 mass %, and more preferably 0.05 to 0.5 mass % relative to the polymerizable composition.

Use of the above-mentioned surfactant enables an optically anisotropic body formed of the polymerizable liquid crystal composition of the present invention to have an effectively reduced tilt angle at the air interface.

Besides the above-mentioned surfactant that enables production of an optically anisotropic body having an effectively reduced tilt angle at the air interface, examples of usable surfactants in the polymerizable liquid crystal composition of the present invention include compounds each having a repeating unit represented by General Formula (7) and a weight average molecular weight of not less than 100.

[Chem. 51]

CR¹¹R¹²—CR¹³R¹⁴ (7)

In the formula, R¹¹, R¹², R¹³, and R¹⁴ each independently represent a hydrogen atom, a halogen atom, or a hydrocarbon group having 1 to 20 carbon atoms; in the hydrocarbon group, a hydrogen atom is optionally substituted with at least one halogen atom.

Examples of preferred compounds represented by General Formula (7) include polyethylene, polypropylene, polyisobutylene, paraffin, liquid paraffin, chlorinated polypropylene, chlorinated paraffin, and chlorinated liquid paraffin.

The amount of the compound represented by General Formula (7) is preferably in the range of 0.01 to 1 mass %, and more preferably 0.05 to 0.5 mass % relative to the polymerizable liquid crystal composition.

### (Curing Agent)

The polymerizable liquid crystal composition of the present invention may contain a curing agent. Specific examples thereof include aliphatic polyamines, such as diethylenetriamine and triethylenetetramine, and ketimine compounds, such as EH-235R-2 manufactured by ADEKA CORPORATION and jERCURE H3 and H30 manufactured by Mitsubishi Chemical Corporation.

The amount of the curing agent to be used is preferably in the range of 0.01 to 20 mass %, more preferably 0.05 to 15 mass %, and especially preferably 0.1 to 10 mass % relative to the polymerizable liquid crystal composition. Such curing agents may be used alone or in combination.

### (Other Additives)

In order to adjust physical properties, additives such as a polymerizable compound having no liquid crystallinity, a thixotropic agent, an ultraviolet absorber, an infrared absorber, an oxidation inhibitor, and a surface preparation agent can be used on the basis of the intended use to such an extent that the orientation of liquid crystal is not greatly impaired.

### (Method for Producing Optically Anisotropic Body)

### (Optically Anisotropic Body)

An optically anisotropic body produced using the polymerizable liquid crystal composition of the present invention has a layered structure including a substrate, an alignment film optionally formed, and the polymer of the polymerizable liquid crystal composition in sequence.

### (Substrate)

Any substrate can be used in the optically anisotropic body of the present invention provided that the substrate can be used in general liquid crystal devices, displays, optical components, and optical films and that the substrate has a heat resistance that allows it to endure heating for drying after application of the polymerizable liquid crystal composition of the present invention. Examples of such a substrate include glass substrates, metal substrates, ceramic substrates, and substrates formed of organic materials, such as plastic substrates. Especially in the case where the substrate is formed of an organic material, examples of the organic material include cellulose derivatives, polyolefin, polyester, polycarbonate, polyacrylate (acrylic resin), polyarylate, polyether sulphone, polyimide, polyphenylene sulfide, polyphenylene ether, nylon, and polystyrene. In particular, plastic substrates formed of polyester, polystyrene, polyacrylate, polyolefin, cellulose derivatives, polyarylate, and polycarbonate are preferred; substrates formed of polyacrylate, polyolefin, and cellulose derivatives are more preferred; and using COP (cycloolefin polymer) as polyolefin, TAC (triacetylcellulose) as a cellulose derivative, and PMMA (polymethyl methacrylate) as polyacrylate is especially preferred. The substrate may have a planar shape or a curved surface. Such a substrate may optionally have an electrode layer, an antireflection function, or a reflection function.

The substrate may be subjected to a surface treatment in order to enable the polymerizable liquid crystal composition of the present invention to be applied and adhere thereto well. Examples of the surface treatment include an ozone treatment, a plasma treatment, a corona treatment, and a silane coupling treatment. The surface of the substrate may be provided with, for example, an organic thin film, an inorganic oxide thin film, a metal thin film by deposition or another technique in order to adjust the transmittance or reflectance of light. Alternatively, the substrate may be, for instance, a pickup lens, a rod lens, an optical disc, a retardation film, a light diffusing film, or a color filter in order to give an optical value. In particular, a pickup lens, a retardation film, a light diffusing film, and a color filter are preferred because they can give a higher optical value.

### (Alignment Treatment)

The substrate may be typically subjected to an alignment treatment or may be provided with an alignment film in order to align the polymerizable liquid crystal composition after the polymerizable liquid crystal composition of the present invention is applied and dried. Examples of the alignment treatment include a stretching treatment, a rubbing treatment, a treatment with radiation of polarized ultraviolet and visible light, and an ion beam treatment. In the case where an alignment film is used, any of known alignment films can be employed. Examples of such alignment films include those formed of compounds, such as polyimide, polysiloxane, polyamide, polyvinyl alcohol, polycarbonate, polystyrene, polyphenylene ether, polyarylate, polyethylene terephthalate, polyether sulfone, epoxy resins, epoxyacrylate resins, acrylic resins, coumarin compounds, chalcone compounds, cinnamate compounds, fulgide compounds, anthraquinone compounds, azo compounds, and arylethene compounds. A compound that is to be rubbed for the alignment treatment is preferably a compound of which the crystallization of the material is promoted by the alignment treatment itself or heating after the alignment treatment. Among compounds that are to be subjected to the alignment treatment other than the rubbing, photo-aligned materials are preferably used.

### (Application)

An application technique for producing the optically anisotropic body of the present invention can be any of known techniques such as a method involving use of an applicator, a bar coating method, a spin coating method, a roll coating method, a direct gravure coating method, a reverse gravure coating method, a flexographic coating method, an inkjet method, a die coating method, a cap coating method, a dip coating method, and a slit coating method. The polymerizable liquid crystal composition is appropriately dried after being applied.

### (Polymerization Process)

The polymerization of the polymerizable liquid crystal composition of the present invention typically involves irradiation with light, such as ultraviolet, or heating in a state in which the liquid crystal compound contained in the polymerizable liquid crystal composition is in horizontal alignment, vertical alignment, hybrid alignment, or cholesteric alignment (planar alignment) with respect to the substrate. Specifically, in the polymerization involving irradiation with light, irradiation with ultraviolet rays having a wavelength of 390 nm or less is preferred, and irradiation with light having a wavelength ranging from 250 to 370 nm is most preferred. If the ultraviolet rays having a wavelength of 390 nm or less causes, for example, decomposition of the polymerizable composition, polymerization involving irradiation with ultraviolet rays having a wavelength of 390 nm or more is suitable in some cases. This light is preferably non-polarized diffused light.

### (Polymerization Technique)

The polymerizable liquid crystal composition of the present invention can be polymerized by irradiation with active energy rays or heating. The irradiation with active energy rays is preferred because it is free from a heating step and enables the reaction to progress at room temperature; in particular, irradiation with light such as ultraviolet is preferred because it can be easily performed.

The temperature in the irradiation procedure is controlled so that the polymerizable liquid crystal composition of the present invention can maintain a liquid crystal phase; in order to prevent the occurrence of thermal polymerization of the polymerizable liquid crystal composition, it is preferred that the temperature be adjusted to be 30° C. or less as much as possible. Liquid crystal compositions are generally in a liquid crystal phase in the temperature range of C (solid phase) to N (nematic) transition temperature (hereinafter referred to as C-N transition temperature) to N-I transition temperature in a heating process. In a cooling process, liquid crystal compositions are in a thermodynamically non-equilibrium state; thus, they are not coagulated and maintain a state of liquid crystal in some cases even at a temperature of C-N transition temperature or lower. This state is called supercooled state. In the present invention, a liquid crystal composition in a supercooled state is also regarded as a liquid crystal phase being maintained. Specifically, irradiation with ultraviolet rays having a wavelength of 390 nm or less is preferred, and irradiation with light having a wavelength ranging from 250 to 370 nm is most preferred. If the ultraviolet rays having a wavelength of 390 nm or less causes, for example, decomposition of the polymerizable composition, polymerization involving irradiation with ultraviolet rays having a wavelength of 390 nm or more is suitable in some cases. The light is preferably non-polarized diffused light. The intensity of ultraviolet radiation is preferably in the range of 0.05 kW/m² to 10 kW/m², and especially preferably 0.2 kW/m² to 2 kW/m². At an intensity of less than 0.05 kW/m², the polymerization procedure takes a lot of time to be completed. At an intensity of greater than 2 kW/m², the liquid crystal molecules in the polymerizable liquid crystal composition are likely to undergo photolysis, and heat of polymerization is greatly generated to increase the temperature in the polymerization procedure, which causes a change in the order parameter of polymerizable liquid crystal with the result that the retardation of a film may be out of order after the polymerization.

An optically anisotropic body having regions with different directions of alignment can be produced as follows: only the intended part is irradiated with ultraviolet rays with a mask to be polymerized, the alignment state of the non-polymerized part is subsequently changed by application of an electric field or magnetic field or by a change in temperature, and then this non-polymerized part is polymerized.

An optically anisotropic body having regions with different directions of alignment can be produced also as follows: the polymerizable liquid crystal composition that has not been polymerized yet is subjected to application of an electric field or magnetic field or a change in temperature in advance to regulate an alignment state before only the intended part is irradiated with ultraviolet rays with a mask to be polymerized, and then polymerization is performed in this state by irradiation with light with a mask.

The optically anisotropic body produced through polymerization of the polymerizable liquid crystal composition of the present invention can be removed from the substrate and used in this state or can be used without being removed from the substrate. In particular, the optically anisotropic body is less likely to contaminate other members and therefore useful as a substrate on which a layer is to be formed or useful for being attached to another substrate.

### (Retardation Film)

The retardation film of the present invention is produced as in the production of the optically anisotropic body of the present invention. In the case where a polymerizable compound represented by General Formula (1) in the polymerizable composition is polymerized in a state of planar alignment, a retardation film to be produced has in-plane birefringence with respect to the substrate. This retardation film can be used as a homogeneous liquid crystal film. In the case where the polymerizable compound represented by General Formula (1) in the polymerizable composition and the polymerizable chiral compound are polymerized in a state of planar alignment, a retardation film to be produced has out-of-plane birefringence with respect to the substrate. In the case where the polymerizable compound represented by General Formula (1) in the polymerizable composition containing a polymerizable discotic compound is polymerized in a state of planar alignment, a retardation film to be produced has both in-plane and out-of-plane birefringence with respect to the substrate.

In the case where the substrate has a phase difference, a retardation film to be produced has birefringence resulting from the combination of the birefringence of the substrate and the birefringence of the retardation film of the present invention. In the retardation film, the birefringence of the substrate and the birefringence of the retardation film may be in the same direction or in different directions in the plane of the substrate. The retardation film is used in the form suitable for applications such as liquid crystal devices, displays, optical devices, optical components, colorants, security marking, laser-emitting members, optical films, and compensation films.

### (Patterned Retardation Film)

The patterned retardation film of the present invention is a laminate including a substrate, an alignment film, and a polymer of the polymerizable composition solution in sequence as in the optically anisotropic body of the present invention. The patterned retardation film is a film patterned so as to have partially-different phase difference in the polymerization process. The pattern may be in the form of a line, lattice, circle, or polygon and may be in different directions. The patterned retardation film is used on the basis of applications such as liquid crystal devices, displays, optical devices, optical components, colorants, security marking, laser-emitting members, optical films, and compensation films.

In order to produce partially-different phase difference, an alignment film is provided on a substrate, and the polymerizable composition is subjected to alignment in a pattern after the polymerizable composition solution of the present invention is applied and dried. Examples of the alignment treatment include fine rubbing, irradiation with polarized ultraviolet and visible light with a photomask, and processing in a fine shape. The alignment film to be used can be any of known alignment films. Examples of the alignment film include those formed of compounds, such as polyimide, polysiloxane, polyamide, polyvinyl alcohol, polycarbonate, polystyrene, polyphenylene ether, polyarylate, polyethylene terephthalate, polyether sulfone, epoxy resins, epoxyacrylate resins, acrylic resins, coumarin compounds, chalcone compounds, cinnamate compounds, fulgide compounds, anthraquinone compounds, azo compounds, and arylethene compounds. A compound that is to be subjected to fine rubbing for the alignment treatment is preferably a compound of which the crystallization of the material is promoted by the alignment treatment itself or heating after the alignment treatment. Among compounds that are to be subjected to the alignment treatment other than the rubbing, photo-aligned materials are preferably used.

### EXAMPLES

The present invention will now be described with reference to Synthesis Examples, Examples, and Comparative Examples but is apparently not limited thereto. The terms “part” and “%” are on a mass basis unless otherwise specified.

### (Preparation of Polymerizable Liquid Crystal Composition)

Compounds were selected from compounds shown in Table 1 and represented by Formulae (A-1) to (A-6), (B-1) to (B-8), and (C-1) and (C-2) in the total amount of 100 parts by mass; and the selected compounds were mixed with any of compounds represented by Formulae (D-1) to (D-18), a compound represented by (E-1), a compound represented by (F-1), and any of compounds represented by (G-1) and (G-2) in the amounts shown in Table 1 (parts by mass). MEK (methyl ethyl ketone) (H-1) was used as an organic solvent such that the total amount of the compounds selected from the compounds represented by Formulae (A-1) to (A-6), (B-1) to (B-8), and (C-1) and (C-2); the compound selected from the compounds represented by Formulae (D-1) to (D-18); the compound represented by (E-1); the compound represented by (F-1); and the compound selected from the compounds represented by (G-1) and (G-2) was 25 mass % in a polymerizable liquid crystal composition, thereby preparing a polymerizable liquid crystal composition (MEK: 75 mass %).

### (Preparation of Polymerizable Liquid Crystal Composition (1))

As shown in Table 1, 20 parts by mass of the compound represented by Formula (A-3), 20 parts by mass of the compound represented by Formula (A-5), 25 parts by mass of the compound represented by Formula (B-5), and 35 parts by mass of the compound represented by Formula (B-7) were prepared; and 5 parts by mass of the compound represented by Formula (D-1), 5 parts by mass of a polymerization initiator (E-1), and 0.1 part by mass of methylhydroquinone (MEHQ) (F-1) relative to 100 parts by mass of the total amount of the above compounds were prepared. The MEK (H-1) was used as an organic solvent such that the total amount of all of those compounds was 25 mass %. This mixture was stirred with a stirrer having a stirring propeller for an hour at a stirring rate of 300 rpm and a solution temperature of 80° C. The resulting product was then filtrated through a membrane filter of 0.2 μm to produce a polymerizable liquid crystal composition (1).

### (Preparation of Polymerizable Liquid Crystal Compositions (2) to (46) and (51) to (75) and Comparative Polymerizable Liquid Crystal Compositions (47) to (50))

The compounds represented by Formulae (A-1) to (A-6), compounds represented by Formulae (B-1) to (B-8), compounds represented by Formulae (C-1) and (C-2), compounds represented by Formulae (D-1) to (D-18), compound represented by (E-1), compound represented by (F-1), compound represented by (G-1), compound represented by (G-2), and compound represented by (J-1), which are all shown in Tables 1 to 4, were used as shown in Table 1. Except for this change, polymerizable liquid crystal compositions (2) to (46) and (51) to (75) and comparative polymerizable liquid crystal compositions (47) to (50) were produced as in the preparation of the polymerizable liquid crystal composition (1) of the present invention.

Tables 1 to 6 show the specific constitution of the polymerizable liquid crystal compositions (1) to (46) and (51) to (75) of the present invention and the specific constitution of the comparative polymerizable liquid crystal compositions (47) to (50).

TABLE 1

| Composition | (1) | (2) | (3) | (4) | (5) | (6) | (7) | (8) | (9) | (10) | (11) | (12) | (13) | (14) |
|---|---|---|---|---|---|---|---|---|---|---|---|---|---|---|
| (A-1) | | | | | | | | | | | | | | |
| (A-2) | | | | | | | | | | | | | | |
| (A-3) | 20 | 20 | 20 | 20 | 20 | 20 | 20 | 20 | 20 | 20 | 20 | 20 | 20 | 20 |
| (A-4) | | | | | | | | | | | | | | |
| (A-5) | 20 | 20 | 20 | 20 | 20 | 20 | 20 | 20 | 20 | 20 | 20 | 20 | 20 | 20 |
| (A-6) | | | | | | | | | | | | | | |
| (B-1) | | | | | | | | | | | | | | |
| (B-2) | | | | | | | | | | | | | | |
| (B-3) | | | | | | | | | | | | | | |
| (B-4) | | | | | | | | | | | | | | |
| (B-5) | 25 | 25 | 25 | 25 | 25 | 25 | 25 | 25 | 25 | 25 | 25 | 25 | 25 | 25 |
| (B-6) | | | | | | | | | | | | | | |
| (B-7) | 35 | 35 | 35 | 35 | 35 | 35 | 35 | 35 | 35 | 35 | 35 | 35 | 35 | 35 |
| (B-8) | | | | | | | | | | | | | | |
| (C-1) | | | | | | | | | | | | | | |
| (C-2) | | | | | | | | | | | | | | |
| (D-1) | 5 | 8 | | | | | | | | | | | | |
| (D-2) | | | 5 | | | | | | | | | | | |
| (D-3) | | | | 5 | | | | | | | | | | |
| (D-4) | | | | | 5 | 10 | | | | | | | | |
| (D-5) | | | | | | | 5 | 5 | 5 | | | | | |
| (D-6) | | | | | | | | | | 5 | | | | |
| (D-7) | | | | | | | | | | | 5 | | | |
| (D-8) | | | | | | | | | | | | 5 | | |
| (D-9) | | | | | | | | | | | | | 5 | |
| (D-10) | | | | | | | | | | | | | | 5 |
| (D-11) | | | | | | | | | | | | | | |
| (D-12) | | | | | | | | | | | | | | |
| (D-13) | | | | | | | | | | | | | | |
| (D-14) | | | | | | | | | | | | | | |
| (D-15) | | | | | | | | | | | | | | |
| (D-16) | | | | | | | | | | | | | | |
| (D-17) | | | | | | | | | | | | | | |
| (E-1) | 5 | 5 | 5 | 5 | 5 | 5 | 5 | 5 | 5 | 5 | 5 | 5 | 5 | 5 |
| (F-1) | 0.1 | 0.1 | 0.1 | 0.1 | 0.1 | 0.1 | 0.1 | 0.1 | 0.1 | 0.1 | 0.1 | 0.1 | 0.1 | 0.1 |
| (G-1) | | | | | | | | 0.6 | | | | | | |
| (G-2) | | | | | | | | | 2.5 | | | | | |
| (H-1) | 75 | 75 | 75 | 75 | 75 | 75 | 75 | 75 | 75 | 75 | 75 | 75 | 75 | 75 |

TABLE 2

| Composition | (15) | (16) | (17) | (18) | (19) | (20) | (21) | (22) | (23) | (24) | (25) | (26) | (27) | (28) |
|---|---|---|---|---|---|---|---|---|---|---|---|---|---|---|
| (A-1) | | | | | | | | | | | | | | |
| (A-2) | | | | | | | | | | | | | | |
| (A-3) | 20 | 20 | 20 | 20 | 20 | 40 | 40 | 40 | 40 | 40 | 10 | 10 | 40 | 40 |
| (A-4) | | | | | | | | | | | | | | |
| (A-5) | 20 | 20 | 20 | 20 | 20 | 10 | 10 | 10 | 10 | 10 | 3 | 3 | | |
| (A-6) | | | | | | | | | | | | | | |
| (B-1) | | | | | | | | | | | | | | |
| (B-2) | | | | | | | | | | | | | | |
| (B-3) | | | | | | | | | | | | | | |
| (B-4) | | | | | | | | | | | | | | |
| (B-5) | 25 | 25 | 25 | 25 | 25 | 25 | 25 | 25 | 25 | 25 | | | 20 | 20 |
| (B-6) | | | | | | 25 | 25 | 25 | 25 | 25 | | | | |
| (B-7) | 35 | 35 | 35 | 35 | 35 | | | | | | 5 | 5 | 40 | 40 |
| (B-8) | | | | | | | | | | | 80 | 80 | | |
| (C-1) | | | | | | | | | | | 2 | 2 | | |
| (C-2) | | | | | | | | | | | | | | |
| (D-1) | | | | | | 5 | | | | | 5 | | 5 | |
| (D-2) | | | | | | | 5 | | | | | | | |
| (D-3) | | | | | | | | 5 | | | | | | |
| (D-4) | | | | | | | | | | | | | | |
| (D-5) | | | | | | | | | 5 | 5 | | 5 | | 5 |
| (D-6) | | | | | | | | | | | | | | |
| (D-7) | | | | | | | | | | | | | | |
| (D-8) | | | | | | | | | | | | | | |
| (D-9) | | | | | | | | | | | | | | |
| (D-10) | | | | | | | | | | | | | | |
| (D-11) | 5 | | | | | | | | | | | | | |
| (D-12) | | 5 | | | | | | | | | | | | |
| (D-13) | | | 5 | | | | | | | | | | | |
| (D-14) | | | | 5 | | | | | | | | | | |
| (D-15) | | | | | 5 | | | | | | | | | |
| (D-16) | | | | | | | | | | | | | | |
| (D-17) | | | | | | | | | | | | | | |
| (E-1) | 5 | 5 | 5 | 5 | 5 | 5 | 5 | 5 | 5 | 5 | 5 | 5 | 5 | 5 |
| (F-1) | 0.1 | 0.1 | 0.1 | 0.1 | 0.1 | 0.1 | 0.1 | 0.1 | 0.1 | 0.1 | 0.1 | 0.1 | 0.1 | 0.1 |
| (G-1) | | | | | | | | | | | | | | |
| (G-2) | | | | | | | | | 2.5 | 2.5 | | 2.5 | | 2.5 |
| (H-1) | 75 | 75 | 75 | 75 | 75 | 75 | 75 | 75 | 75 | 75 | 75 | 75 | 75 | 75 |

TABLE 3

| Composition | (29) | (30) | (31) | (32) | (33) | (34) | (35) | (36) | (37) | (38) | (39) | (40) | (41) | (42) |
|---|---|---|---|---|---|---|---|---|---|---|---|---|---|---|
| (A-1) | 42.5 | 42.5 | 42.5 | 42.5 | 42.5 | 42.5 | 42.5 | 37.5 | 37.5 | 35 | 35 | 15 | 15 | |
| (A-2) | 42.5 | 42.5 | 42.5 | 42.5 | 42.5 | 42.5 | 42.5 | 37.5 | 37.5 | 35 | 35 | 45 | 45 | |
| (A-3) | | | | | | | | | | | | | | 35 |
| (A-4) | | | | | | | | | | | | | | 35 |
| (A-5) | | | | | | | | 10 | 10 | 15 | 15 | | | |
| (A-6) | | | | | | | | | | | | 40 | 40 | |
| (B-1) | 15 | 15 | 15 | 15 | 15 | 15 | 15 | 15 | 15 | | | | | |
| (B-2) | | | | | | | | | | 15 | 15 | | | |
| (B-3) | | | | | | | | | | | | | | 15 |
| (B-4) | | | | | | | | | | | | | | 15 |
| (B-5) | | | | | | | | | | | | | | |
| (B-6) | | | | | | | | | | | | | | |
| (B-7) | | | | | | | | | | | | | | |
| (B-8) | | | | | | | | | | | | | | |
| (C-1) | | | | | | | | | | | | | | |
| (C-2) | | | | | | | | | | | | | | |
| (D-1) | 5 | 5 | 8 | | | | | 5 | | 5 | | 5 | | 5 |
| (D-2) | | | | | | | | | | | | | | |
| (D-3) | | | | | | | | | | | | | | |
| (D-4) | | | | 5 | | | | | | | | | | |
| (D-5) | | | | | 5 | 5 | 5 | | 5 | | 5 | | 5 | |
| (D-6) | | | | | | | | | | | | | | |
| (D-7) | | | | | | | | | | | | | | |
| (D-8) | | | | | | | | | | | | | | |
| (D-9) | | | | | | | | | | | | | | |
| (D-10) | | | | | | | | | | | | | | |
| (D-11) | | | | | | | | | | | | | | |
| (D-12) | | | | | | | | | | | | | | |
| (D-13) | | | | | | | | | | | | | | |
| (D-14) | | | | | | | | | | | | | | |
| (D-15) | | | | | | | | | | | | | | |
| (D-16) | | | | | | | | | | | | | | |
| (D-17) | | | | | | | | | | | | | | |
| (E-1) | 3 | 3 | 3 | 3 | 3 | 3 | 3 | 3 | 3 | 3 | 3 | 3 | 3 | 3 |
| (F-1) | 0.1 | 0.1 | 0.1 | 0.1 | 0.1 | 0.1 | 0.1 | 0.1 | 0.1 | 0.1 | 0.1 | 0.1 | 0.1 | 0.1 |
| (G-1) | | | | | | 0.6 | | | | | | | | |
| (G-2) | | | | | | | 2.5 | | 2.5 | | 2.5 | | 2.5 | |
| (H-1) | 75 | 75 | 75 | 75 | 75 | 75 | 75 | 75 | 75 | 75 | 75 | 75 | 75 | 75 |

TABLE 4

| Composition | (43) | (44) | (45) | (46) | (47) | (48) | (49) | (50) |
|---|---|---|---|---|---|---|---|---|
| (A-1) | | | | | | | | 42.5 |
| (A-2) | | | | | | | | 42.5 |
| (A-3) | 35 | 35 | 40 | 40 | 20 | 20 | 20 | |
| (A-4) | 35 | 35 | 34 | 34 | | | | |
| (A-5) | | | | | 20 | 20 | 20 | |
| (A-6) | | | | | | | | |
| (B-1) | | | | | | | | 15 |
| (B-2) | | | | | | | | |
| (B-3) | 15 | 15 | | | | | | |
| (B-4) | 15 | 15 | 18 | 18 | | | | |
| (B-5) | | | | | 25 | 25 | 25 | |
| (B-6) | | | | | | | | |
| (B-7) | | | | | 35 | 35 | 35 | |
| (B-8) | | | | | | | | |
| (C-1) | | | | | | | | |
| (C-2) | | | 8 | 8 | | | | |
| (D-1) | | | 5 | | | | | |
| (D-2) | | | | | | | | |
| (D-3) | | | | | | | | |
| (D-4) | | | | | | | | |
| (D-5) | 5 | 5 | | 5 | | | | |
| (D-6) | | | | | | | | |
| (D-7) | | | | | | | | |
| (D-8) | | | | | | | | |
| (D-9) | | | | | | | | |
| (D-10) | | | | | | | | |
| (D-11) | | | | | | | | |
| (D-12) | | | | | | | | |
| (D-13) | | | | | | | | |
| (D-14) | | | | | | | | |
| (D-15) | | | | | | | | |
| (D-16) | | | | | | 0.5 | | |
| (D-17) | | | | | | | 2 | |
| (E-1) | 3 | 3 | 3 | 3 | 5 | 5 | 5 | 3 |
| (F-1) | 0. 1 | 0.1 | 0.1 | 0.1 | 0.1 | 0.1 | 0.1 | 0.1 |
| (G-1) | | | | | | | | |
| (G-2) | | 2.5 | | 2.5 | | | | |
| (H-1) | 75 | 75 | 75 | 75 | 75 | 75 | 75 | 75 |

TABLE 5

| Composition | (51) | (52) | (53) | (54) | (55) | (56) | (57) | (58) | (59) | (60) | (61) | (62) |
|---|---|---|---|---|---|---|---|---|---|---|---|---|
| (A-1) | 42.5 | 42.5 | 42.5 | 42.5 | 42.5 | 42.5 | 42.5 | 42.5 | 42.5 | 42.5 | 42.5 | 42.5 |
| (A-2) | 42.5 | 42.5 | 42.5 | 42.5 | 42.5 | 42.5 | 42.5 | 42.5 | 42.5 | 42.5 | 42.5 | 42.5 |
| (A-3) | | | | | | | | | | | | |
| (A-4) | | | | | | | | | | | | |
| (A-5) | | | | | | | | | | | | |
| (A-6) | | | | | | | | | | | | |
| (B-1) | 15 | 15 | 15 | 15 | 15 | 15 | 15 | 15 | 15 | 15 | 15 | 15 |
| (B-2) | | | | | | | | | | | | |
| (B-3) | | | | | | | | | | | | |
| (B-4) | | | | | | | | | | | | |
| (B-5) | | | | | | | | | | | | |
| (B-6) | | | | | | | | | | | | |
| (B-7) | | | | | | | | | | | | |
| (B-8) | | | | | | | | | | | | |
| (C-1) | | | | | | | | | | | | |
| (C-2) | | | | | | | | | | | | |
| (D-1) | 5 | | | | | | | | | | | |
| (D-2) | | | | | 5 | | | | | | | |
| (D-3) | | | | | | 5 | | | | | | |
| (D-4) | | 5 | | | | | | | | | | |
| (D-5) | | | 5 | 5 | | | | | | | | |
| (D-6) | | | | | | | 5 | | | | | |
| (D-7) | | | | | | | | 5 | | | | |
| (D-8) | | | | | | | | | 5 | | | |
| (D-9) | | | | | | | | | | 5 | | |
| (D-10) | | | | | | | | | | | 5 | |
| (D-11) | | | | | | | | | | | | 5 |
| (D-12) | | | | | | | | | | | | |
| (D-13) | | | | | | | | | | | | |
| (D-14) | | | | | | | | | | | | |
| (D-15) | | | | | | | | | | | | |
| (D-16) | | | | | | | | | | | | |
| (D-17) | | | | | | | | | | | | |
| (E-1) | 3 | 3 | 3 | 3 | 3 | 3 | 3 | 3 | 3 | 3 | 3 | 3 |
| (F-1) | 0.1 | 0.1 | 0.1 | 0.1 | 0.1 | 0.1 | 0.1 | 0.1 | 0.1 | 0.1 | 0.1 | 0.1 |
| (G-1) | | | | 0.6 | | | | | | | | |
| (G-2) | | | | | | | | | | | | |
| (J-1) | 0.05 | 0.05 | 0.05 | 0.05 | 0.05 | 0.05 | 0.05 | 0.05 | 0.05 | 0.05 | 0.05 | 0.05 |
| (H-1) | 75 | 75 | 75 | 75 | 75 | 75 | 75 | 75 | 75 | 75 | 75 | 75 |

TABLE 6

| Composition | (63) | (64) | (65) | (66) | (67) | (68) | (69) | (70) | (71) | (72) | (73) | (74) | (75) |
|---|---|---|---|---|---|---|---|---|---|---|---|---|---|
| (A-1) | 42.5 | 42.5 | 42.5 | 42.5 | 25 | 25 | 25 | 25 | 25 | 25 | 50 | 50 | |
| (A-2) | 42.5 | 42.5 | 42.5 | 42.5 | 25 | 25 | 25 | 25 | 25 | 25 | 50 | 50 | |
| (A-3) | | | | | | | | | | | | | 20 |
| (A-4) | | | | | 15 | 15 | 15 | 15 | 15 | 15 | | | |
| (A-5) | | | | | 20 | 20 | 20 | 20 | 20 | 20 | | | 20 |
| (A-6) | | | | | | | | | | | | | |
| (B-1) | 15 | 15 | 15 | 15 | 15 | 15 | 15 | 15 | 15 | 15 | | | |
| (B-2) | | | | | | | | | | | | | |
| (B-3) | | | | | | | | | | | | | |
| (B-4) | | | | | | | | | | | | | |
| (B-5) | | | | | | | | | | | | | 25 |
| (B-6) | | | | | | | | | | | | | |
| (B-7) | | | | | | | | | | | | | 35 |
| (B-8) | | | | | | | | | | | | | |
| (C-1) | | | | | | | | | | | | | |
| (C-2) | | | | | | | | | | | | | |
| (D-1) | | | | | 5 | | | | | | 5 | | |
| (D-2) | | | | | | 5 | | | | | | | |
| (D-3) | | | | | | | 5 | | | | | | |
| (D-4) | | | | | | | | | 5 | | | | |
| (D-5) | | | | | | | | 5 | | | | 5 | |
| (D-6) | | | | | | | | | | 5 | | | |
| (D-7) | | | | | | | | | | | | | |
| (D-8) | | | | | | | | | | | | | |
| (D-9) | | | | | | | | | | | | | |
| (D-10) | | | | | | | | | | | | | |
| (D-11) | | | | | | | | | | | | | |
| (D-12) | 5 | | | | | | | | | | | | |
| (D-13) | | 5 | | | | | | | | | | | |
| (D-14) | | | 5 | | | | | | | | | | |
| (D-15) | | | | 5 | | | | | | | | | |
| (D-16) | | | | | | | | | | | | | |
| (D-17) | | | | | | | | | | | | | |
| (D-18) | | | | | | | | | | | | | 5 |
| (E-1) | 3 | 3 | 3 | 3 | 3 | 3 | 3 | 3 | 3 | 3 | 3 | 3 | 5 |
| (F-1) | 0.1 | 0.1 | 0.1 | 0.1 | 0.1 | 0.1 | 0.1 | 0.1 | 0.1 | 0.1 | 0.1 | 0.1 | 0.1 |
| (J-1) | 0.05 | 0.05 | 0.05 | 0.05 | 0.05 | 0.05 | 0.05 | 0.05 | 0.05 | 0.05 | 0.05 | 0.05 | |
| (H-1) | 75 | 75 | 75 | 75 | 75 | 75 | 75 | 75 | 75 | 75 | 75 | 75 | 75 |

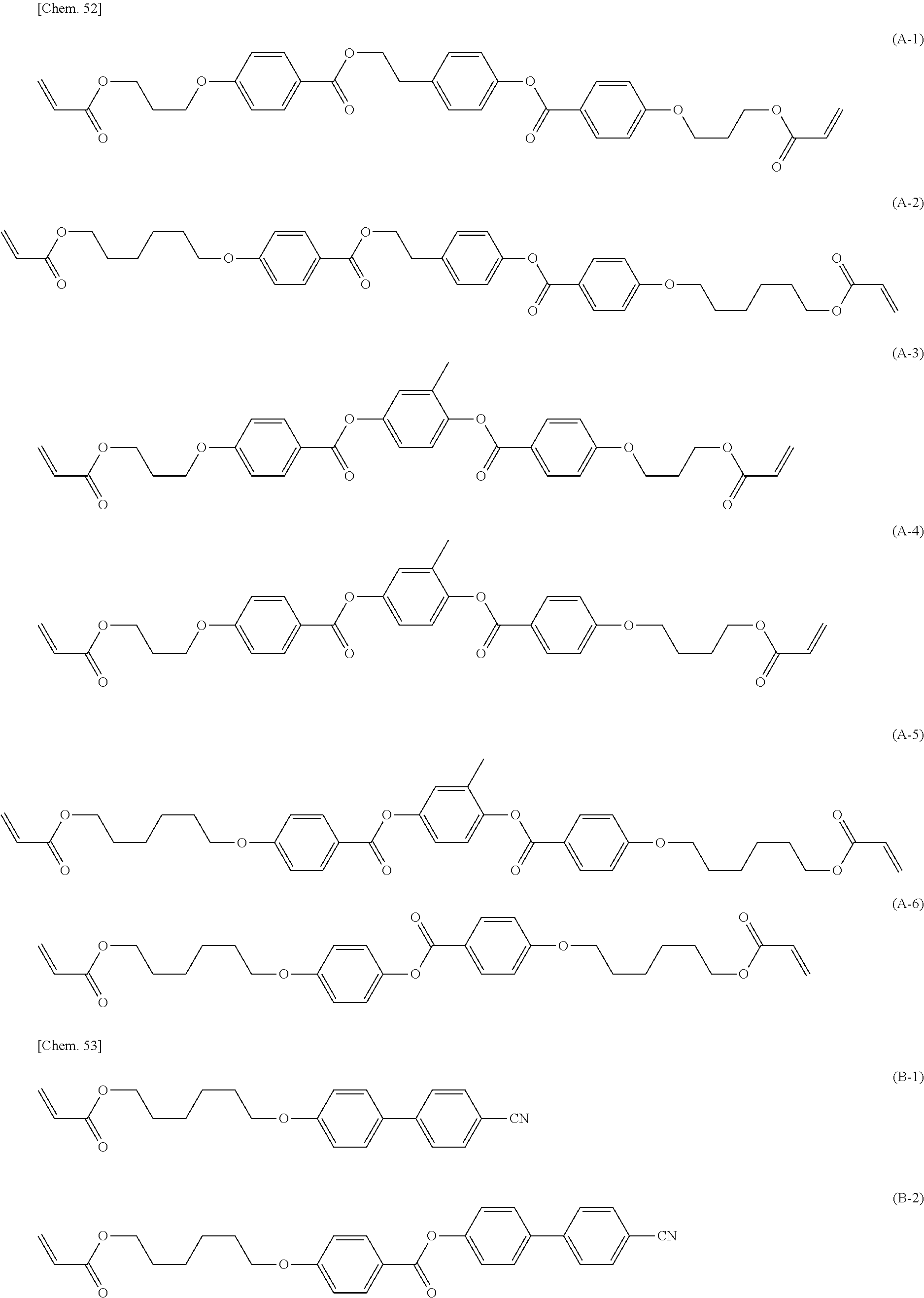

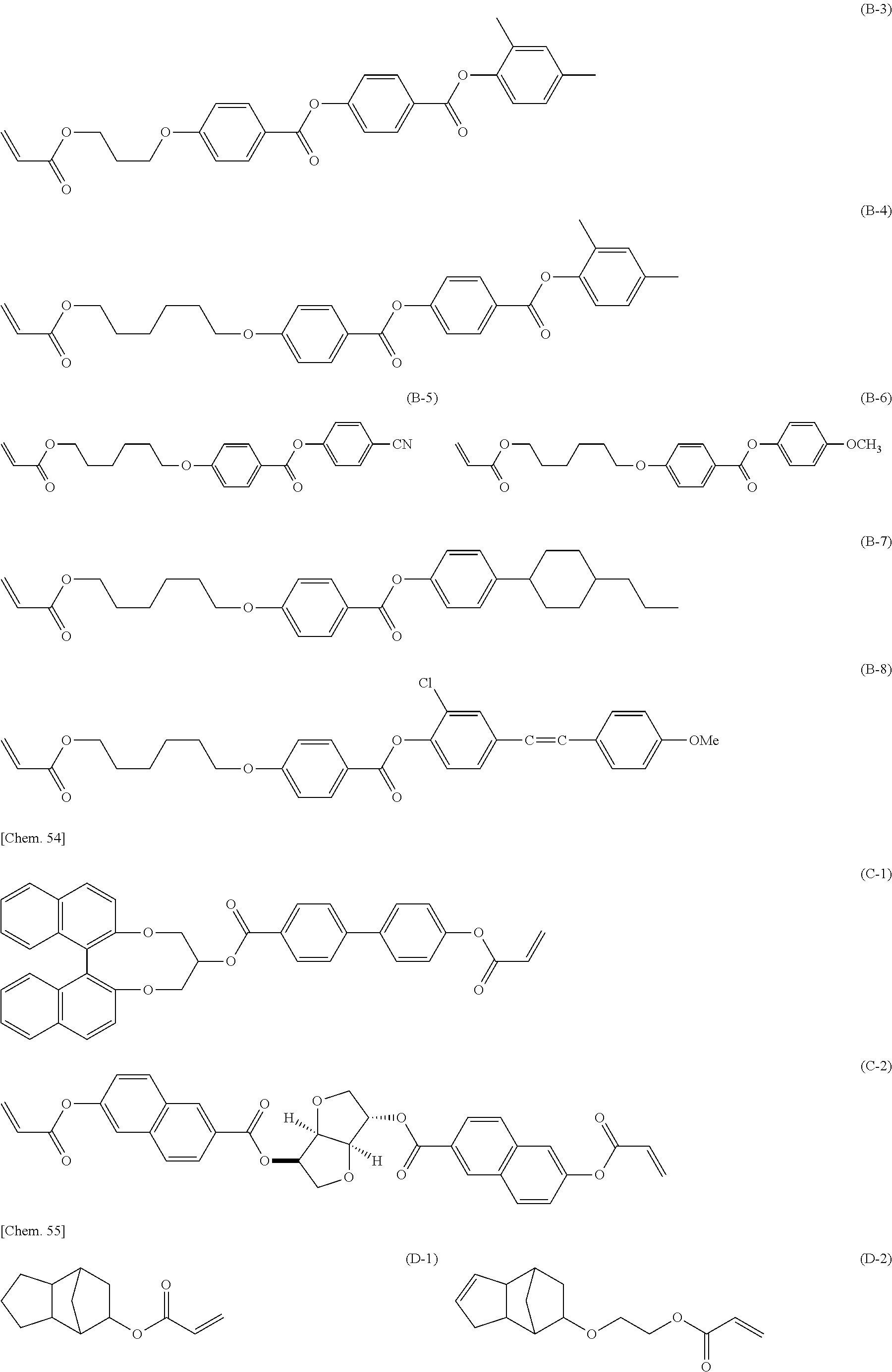

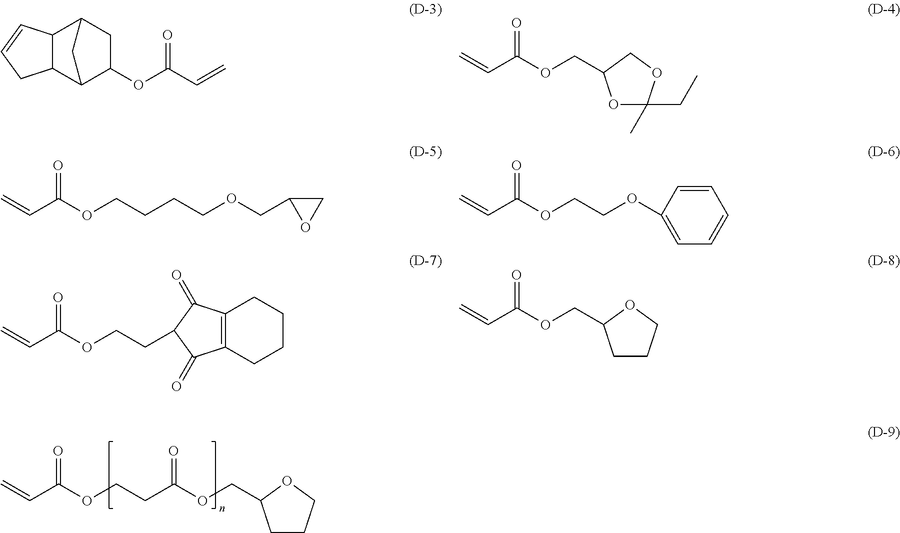

n is from 0 to 6, and the molecular weight of (D-9) is from 150 to 550 g/mol.

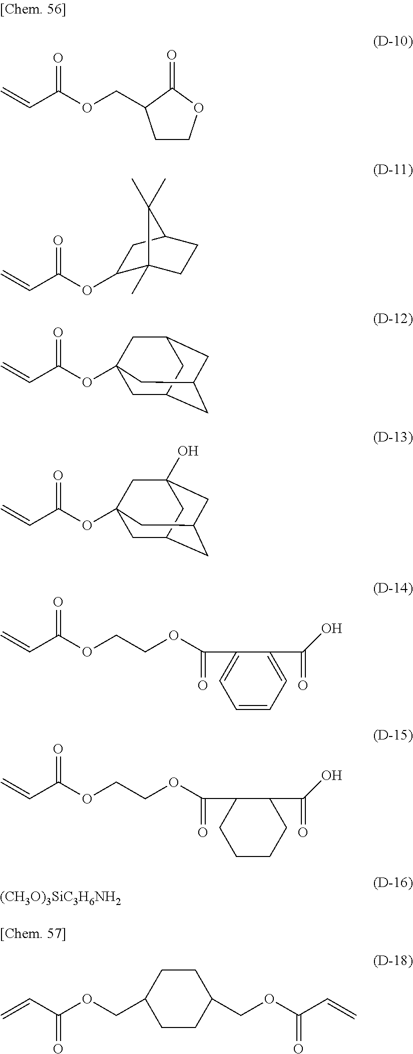

Laromer LR-9000 ((diacrylate having two isocyanate groups per molecule, manufactured by BASF Japan Ltd.) (D-17) Irgacure 907 (E-1)

### MEHQ (F-1)

### Triethylenetetramine (G-1)

Ketimine compounds (jERCURE H3) (G-2)
MEGAFAC F-554 (manufactured by DIC Corporation) (J-1)

### Example 1

### (Storage Stability)

The prepared polymerizable liquid crystal composition (1) was stored at 40° C. for a month and then subjected to measurement of an increase in the proportion of the polymer component in the composition (%). The amounts of the polymer component before and after the storage were measured, and the increase in the proportion of the polymer component (%) was calculated from the follow formula: {(amount of polymer component after storage)−(amount of polymer component before storage)}/{amount of polymer component before storage)}×100. The measurement of the polymer component was performed with a GPC apparatus.

### (Adhesion)

<Production of Film Used for Evaluating Adhesion>

The polymerizable liquid crystal composition (1) and a silane coupling material used for forming a vertical alignment film (DMOAP manufactured by JNC CORPORATION) were applied to a COP film substrate at room temperature by spin coating and then baked at 100° C. for an hour to produce a base material. The base material was coated using a #5 bar coater and then dried at 80° C. for 2 minutes. The product was left to stand at room temperature for 5 minutes and irradiated with UV light with a conveyor-type high pressure mercury lamp at an intensity of 500 mJ/cm² to produce a film of Example 1.

### <Evaluation of Adhesion>

In order to evaluate the adhesion of the film produced as described above, the film was cut in with a cutter by a cross-cut method in accordance with JIS K5600-5-6 to form a grid of 2-mm squares.

Class 0: No square of grid was peeled off
Class 1: Coating film was slightly peeled off at intersection of cut lines (less than 5%)
Class 2: Coating film was peeled off along cut lines at intersection of cut lines (5% or more and less than 15%)
Class 3: Coating film was partially or completely peeled off along cut lines (15% or more and less than 35%)
Class 4: Coating film was partially or completely peeled off along cut lines to a larger extent (35% or more and less than 65%)
Class 5: More than Class 4

### (Orientation)

The polymerizable liquid crystal composition (1) was applied onto a TAC (triacetylcellulose) film at room temperature with a #5 bar coater and then dried at 80° C. for 2 minutes. Then, the resulting product was left to stand at room temperature for 15 minutes and irradiated with UV rays with a conveyor-type high-pressure mercury lamp at the integral of light of 500 mJ/cm².

Excellent: Problem was not found through visual observation and observation with polarizing microscope
Good: Problem was not found through visual observation, but non-orientation was found in some parts through observation with polarizing microscope
Bad: Problem was not found through visual observation, but non-orientation was entirely found through observation with polarizing microscope
Poor: Problem was found in some parts through visual observation, and non-orientation was entirely found through observation with polarizing microscope
The following tables show results of the evaluations.

TABLE 7

| | Solution | Storage stability | Adhesion | Orientation |
|---|---|---|---|---|
| Example 1 | Solution (1) | 2.0 | 0 | Excellent |
| Example 2 | Solution (2) | 1.5 | 0 | Excellent |
| Example 3 | Solution (3) | 2.0 | 0 | Excellent |
| Example 4 | Solution (4) | 2.0 | 0 | Excellent |
| Example 5 | Solution (5) | 2.5 | 0 | Excellent |
| Example 6 | Solution (6) | 1.5 | 0 | Excellent |
| Example 7 | Solution (7) | 2.0 | 1 | Excellent |
| Example 8 | Solution (8) | 4.0 | 0 | Excellent |
| Example 9 | Solution (9) | 2.5 | 0 | Excellent |
| Example 10 | Solution (10) | 1.0 | 2 | Excellent |
| Example 11 | Solution (11) | 1.5 | 2 | Excellent |
| Example 12 | Solution (12) | 1.0 | 2 | Excellent |
| Example 13 | Solution (13) | 1.0 | 2 | Excellent |
| Example 14 | Solution (14) | 2.0 | 2 | Excellent |

TABLE 8

| | Solution | Storage stability | Adhesion | Orientation |
|---|---|---|---|---|
| Example 15 | Solution (15) | 1.0 | 2 | Excellent |
| Example 16 | Solution (16) | 1.0 | 2 | Excellent |
| Example 17 | Solution (17) | 1.5 | 2 | Excellent |
| Example 18 | Solution (18) | 2.5 | 2 | Excellent |
| Example 19 | Solution (19) | 2.5 | 2 | Excellent |
| Example 20 | Solution (20) | 2.0 | 0 | Excellent |
| Example 21 | Solution (21) | 2.0 | 0 | Excellent |
| Example 22 | Solution (22) | 2.0 | 0 | Excellent |
| Example 23 | Solution (23) | 2.5 | 0 | Excellent |
| Example 24 | Solution (24) | 2.5 | 0 | Excellent |
| Example 25 | Solution (25) | 2.5 | 0 | Excellent |
| Example 26 | Solution (26) | 3.0 | 0 | Excellent |
| Example 27 | Solution (27) | 2.0 | 0 | Excellent |
| Example 28 | Solution (28) | 2.5 | 0 | Excellent |

TABLE 9

| | Solution | Storage stability | Adhesion | Orientation |
|---|---|---|---|---|
| Example 29 | Solution (29) | 2.0 | 0 | Excellent |
| Example 30 | Solution (30) | 2.0 | 0 | Excellent |
| Example 31 | Solution (31) | 1.5 | 0 | Good |
| Example 32 | Solution (32) | 2.5 | 0 | Excellent |
| Example 33 | Solution (33) | 2.0 | 1 | Excellent |
| Example 34 | Solution (34) | 4.0 | 0 | Excellent |
| Example 35 | Solution (35) | 2.5 | 0 | Excellent |
| Example 36 | Solution (36) | 2.5 | 0 | Excellent |
| Example 37 | Solution (37) | 2.5 | 0 | Excellent |
| Example 38 | Solution (38) | 2.0 | 0 | Excellent |
| Example 39 | Solution (39) | 2.5 | 0 | Excellent |
| Example 40 | Solution (40) | 2.5 | 0 | Excellent |
| Example 41 | Solution (41) | 2.5 | 0 | Excellent |
| Example 42 | Solution (42) | 2.0 | 0 | Excellent |

TABLE 10

| | | Storage | | |
|---|---|---|---|---|
| | Solution | stability | Adhesion | Orientation |
| Example 43 | Solution (43) | 2.5 | 0 | Excellent |
| Example 44 | Solution (44) | 2.5 | 0 | Excellent |
| Example 45 | Solution (45) | 2.0 | 0 | Excellent |
| Example 46 | Solution (46) | 3.0 | 0 | Excellent |
| Comparative | Solution (47) | 1.0 | 5 | Excellent |
| Example 1 | | | | |
| Comparative | Solution (48) | 8.0 | 1 | Good |
| Example 2 | | | | |
| Comparative | Solution (49) | 10.0 | 0 | Bad |
| Example 3 | | | | |
| Comparative | Solution (50) | 1.0 | 5 | Excellent |
| Example 4 | | | | |

TABLE 11

| | Solution | Storage stability | Adhesion | Orientation |
|---|---|---|---|---|
| Example 47 | Solution (51) | 2.0 | 0 | Excellent |
| Example 48 | Solution (52) | 2.5 | 0 | Excellent |
| Example 49 | Solution (53) | 2.0 | 1 | Excellent |
| Example 50 | Solution (54) | 4.0 | 0 | Excellent |
| Example 51 | Solution (55) | 1.0 | 0 | Excellent |
| Example 52 | Solution (56) | 1.0 | 0 | Excellent |
| Example 53 | Solution (57) | 1.0 | 0 | Excellent |
| Example 54 | Solution (58) | 1.5 | 0 | Excellent |
| Example 55 | Solution (59) | 1.0 | 0 | Excellent |
| Example 56 | Solution (60) | 1.0 | 0 | Excellent |
| Example 57 | Solution (61) | 1.5 | 0 | Excellent |
| Example 58 | Solution (62) | 1.0 | 0 | Excellent |

TABLE 12

| | Solution | Storage stability | Adhesion | Orientation |
|---|---|---|---|---|
| Example 59 | Solution (63) | 1.0 | 0 | Excellent |
| Example 60 | Solution (64) | 1.0 | 0 | Excellent |
| Example 61 | Solution (65) | 2.0 | 0 | Excellent |
| Example 62 | Solution (66) | 2.0 | 0 | Excellent |
| Example 63 | Solution (67) | 1.0 | 0 | Excellent |
| Example 64 | Solution (68) | 1.0 | 0 | Excellent |
| Example 65 | Solution (69) | 1.0 | 0 | Excellent |
| Example 66 | Solution (70) | 1.0 | 0 | Excellent |
| Example 67 | Solution (71) | 1.0 | 0 | Excellent |
| Example 68 | Solution (72) | 1.0 | 0 | Excellent |
| Example 69 | Solution (73) | 1.5 | 0 | Excellent |
| Example 70 | Solution (74) | 1.5 | 0 | Excellent |
| Example 71 | Solution (75) | 3.0 | 3 | Bad |

### Examples 2 to 71 and Comparative Examples 1 to 4

As in Example 1, the polymerizable liquid crystal compositions (2) to (75) were used to measure storage stability, adhesion, and orientation. Results of the measurements are shown in the above tables in the name of Examples 2 to 71 and Comparative Examples 1 to 4. Each of the base materials of the films used for evaluating adhesion was the laminate including a COP film substrate and a silane-coupling vertical alignment film formed thereon as in Example 1 in Examples 2 to 19, 30, 63 to 68, and 71 and Comparative Examples 1 to 3; a TAC film substrate in Examples 20 to 23, Examples 25 to 28, and Example 42, 43, 45, 46, 69, and 70; a PMMA film substrate in Examples 24 and 44; and a COP film substrate (no vertical alignment film) in Examples 29, 31 to 41, and 47 to 62 and Comparative Example 4.

Each of the polymerizable liquid crystal compositions (Examples 1 to 71) containing any of the polymerizable adhesion enhancers represented by Formulae (D-1) to (D-15) had an excellent storage stability; in addition, it had an excellent adhesion to the base material and enabled production of an optically anisotropic body having an excellent orientation as compared with the polymerizable liquid crystal compositions (Comparative Examples 1 and 4) that were free from a polymerizable adhesion enhancer. The polymerizable liquid crystal composition (Example 71) containing the polymerizable adhesion enhancer represented by Formula (D-18) had two polymerizable groups and therefore had smaller storage stability, adhesion, and orientation than compositions containing the compounds represented by Formulae (D-1) to (D-15) and each having one polymerizable group. Each of the polymerizable liquid crystal compositions (Comparative Examples 2 and 3) not containing the polymerizable adhesion enhancer of the present invention but containing another polymerizable adhesion enhancer had an improved adhesion to the base material; however, it had and unsatisfactory storage stability and thus was inadequate to produce an optically anisotropic body having a good orientation.

1. A polymerizable liquid crystal composition comprising at least one polymerizable adhesion enhancer and at least one polymerizable liquid crystal compound.

2. The polymerizable liquid crystal composition according to claim 1, wherein the polymerizable adhesion enhancer is a compound (I) having at least one polymerizable functional group and a cyclic compound group having 1 to 4 rings.

3. The polymerizable liquid crystal composition according to claim 2, wherein the compound (I) is at least one compound selected from a group consisting of compounds represented by General Formula (I-1)
P¹-Z^{A1}-A¹Z^{A2}ₘ (I-1)
(where P¹ represents a polymerizable functional group;
Z^{A1} represents a single bond or an alkylene group having 1 to 16 carbon atoms; the alkylene group may be linear or branched; in the alkylene group, one or more CH₂ groups are each independently optionally substituted with —O—, —CO—, —COO—, —OCO—, —OCOO—, —CH═CH—, or —C≡C— such that oxygen atoms are not directly bonded to each other;
A¹ represents a cyclic compound group having 1 to 4 rings;
Z^{A2} represents a hydroxyl group, a carboxy group, or an alkyl group having 1 to 16 carbon atoms; the alkyl group may be linear or branched; in the alkyl group, one or more CH₂ groups are each independently optionally substituted with —O—, —CO—, —COO—, or —OCO— such that oxygen atoms are not directly bonded to each other;
m represents 0, 1, 2, or 3; and in the case where m represents 2 or 3, the multiple Z^{A2}'s may be the same as or different from each other).

4. The polymerizable liquid crystal composition according to claim 3, wherein A¹ in the compound (I-1) is at least one compound selected from the group consisting of compounds represented by General Formulae (I-1-1) to (I-1-11) 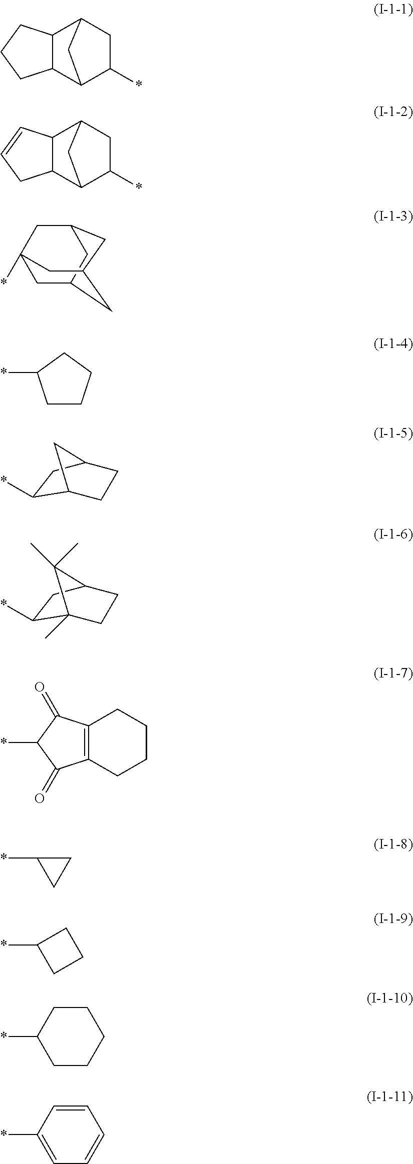
(where the symbol * represents a linkage to Z^{A1}; in General Formulae (I-1-1) to (I-1-11), one or more methylene groups are each independently optionally substituted with an oxygen atom, a nitrogen atom, a sulfur atom, or —CO— such that oxygen atoms are not directly bonded to each other; in the case where the linking groups of Z^{A1} and/or Z^{A2} bonded to A¹ are each an oxygen atom, the linking atom of A¹ that is directly bonded to this oxygen atom is not an oxygen atom).

5. The polymerizable liquid crystal composition according to claim 1, wherein the polymerizable liquid crystal compound is a compound represented by General Formula (II)
P²—(S¹—X¹)_{q1}-MG-R² (II)
(where P² represents a polymerizable functional group;
S¹ represents an alkylene group having 1 to 18 carbon atoms (in the alkylene group, a hydrogen atom is optionally substituted with at least one halogen atom or CN; and one CH₂ group or two or more CH₂ groups not adjoining each other are each independently optionally substituted with —O—, —COO—, —OCO—, or —OCO—O—); X¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond (where P²—S¹ and S—X¹ exclude —O—O—, —O—NH—, —S—S—, and —O—S—);
q1 represents 0 or 1;
MG represents a mesogenic group;
R² represents a hydrogen atom, a halogen atom, a cyano group, or a linear or branched alkyl group having 1 to 12 carbon atoms; the alkyl group may be linear or branched; in the alkyl group, one —CH₂— or two or more —CH₂—'s not adjoining each other are each independently optionally substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—; and R² alternatively represents a group represented by General Formula (II-a)
—(X²—S²)_{q2}—P³ (II-a)
(where P³ represents a reactive functional group;
S² has the same definition as S¹;
X² has the same definition as X¹ (where P³—S² and S²—X² exclude —O—O—, —O—NH—, —S—S—, and —O—S—); and q² represents 0 or 1).

6. The polymerizable liquid crystal composition according to claim 5, wherein the compound represented by General Formula (II) is a compound in which MG is represented by General Formula (II-b)
—(B1-Z1)ᵣ₁—B2-Z2-B3 (II-b)
(where B1, B2, and B3 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group and optionally have, as a substituent, at least one selected from F, Cl, CF₃, OCF₃, a CN group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkenyl group having 2 to 8 carbon atoms, an alkenyloxy group having 2 to 8 carbon atoms, an alkenoyl group having 2 to 8 carbon atoms, an alkenoyloxy group having 2 to 8 carbon atoms, and/or General Formula (II-c)
—(X³)_{q4}—(S³)_{q3}—P⁴ (II-c)
(where P⁴ represents a reactive functional group;
S³ represents an alkylene group having 1 to 18 carbon atoms; X³ represents —O—, —COO—, —OCO—, —OCH₂—, —CH₂O—, —CH₂CH₂OCO—, or —CH₂CH₂COO—; q represents 0 or 1; q⁴ represents 0 or 1 (where P⁴—S³ and S³—X³ exclude —O—O—, —O—NH—, —S—S—, and —O—S—));
Z1 and Z2 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms and optionally a halogen atom, or a single bond;
r1 represents 0, 1, or 2; and in the case where B1 and Z1 are multiple, corresponding ones of them may be the same as or different from each other).

7. The polymerizable liquid crystal composition according to claim 6, wherein the compound represented by General Formula (II) is at least one compound selected from the group consisting of compounds represented by General Formula (II-2-2-2)
P²—(S¹—X¹)_{q1}-B11-Z11-B2-Z2-B3-(X²—S²)_{q2}—P³ (II-2-2-2)
(where P² and P³ each independently represent a polymerizable functional group; S¹ and S² each independently represent an alkylene group having 0 to 18 carbon atoms (in the alkylene group, a hydrogen atom is optionally substituted with at least one halogen atom, CN group, or alkyl group having 1 to 8 carbon atoms and a polymerizable functional group; and one CH₂ group or two or more CH₂ groups not adjoining each other are each independently optionally substituted with —O—, —COO—, —OCO—, or —OCO—O—); X¹ and X² each independently represent —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂OCO—, —CH═CH—, —N═N—, —CH═N—N═CH—, —CF═CF—, —C≡C—, or a single bond (where P²—S¹ and S¹—X¹ exclude —O—O—, —O—NH—, —S—S—, and —O—S—); q1 and q2 each independently represent 0 or 1;
B11, B2, and B3 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group and optionally have, as a substituent, at least one selected from F, Cl, CF₃, OCF₃, a CN group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, and an alkenoyloxy group having 2 to 8 carbon atoms; and Z11 and Z2 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, an alkyl group having 2 to 10 carbon atoms and optionally a halogen atom, or a single bond).

8. A polymer produced through polymerization of the polymerizable liquid crystal composition according to claim 1.

9. An optically anisotropic body produced by using the polymerizable liquid crystal composition according to claim 1.

10. A retardation film produced by using the polymerizable liquid crystal composition according to claim 1.

11. A patterned retardation film produced by using the polymerizable liquid crystal composition according to claim 1.

12. A brightness-enhancing film produced by using the polymerizable liquid crystal composition according to claim 1.

13. An antireflection film produced by using the polymerizable liquid crystal composition according to claim 1.
